(19) United States
(12) Patent Application Publication
(10) Pub. No.: US 2025/0139684 A1
(43) Pub. Date: May 1, 2025

(54) HYBRID INTERFACE WITH AI-ENABLED SYSTEM FOR LIVE EVENT TICKET BOOKING

(71) Applicant: Live Nation Entertainment, Inc., Beverly Hills, CA (US)

(72) Inventors: Ashish Ravindra Gupta, Los Angeles, CA (US); Ari Rose Brown, Los Angeles, CA (US)

(73) Assignee: Live Nation Entertainment, Inc., Beverly Hills, CA (US)

(21) Appl. No.: 18/932,362

(22) Filed: Oct. 30, 2024

Related U.S. Application Data
(60) Provisional application No. 63/594,360, filed on Oct. 30, 2023.

(51) Int. Cl. G06Q 30/0601; G06F 16/332; G06F 40/30; G06Q 10/02; H04L 51/02

(52) U.S. Cl. CPC G06Q 30/0631; G06F 16/3329; G06F 40/30; G06Q 10/02; H04L 51/02

(57) ABSTRACT

A multi-modal e-commerce system for providing artificial intelligence (AI)-based ticket booking to a plurality of users, comprising a system application running on a user device and an AI-enabled engine. The system application includes a hybrid interface, which includes a first interface and a second interface. The first interface is configured to receive user input in a natural language via a chatbot. The AI-enabled engine processes the user input to generate a searchable query. It uses the searchable query from the user input as one or more keywords to identify a plurality of results. A textual output is generated in the natural language on the first interface based on the plurality of results, and a visual output is generated on the second interface based on the plurality of results. The plurality of results is based on user demographics, preferences, and user feedback from an event database.

### PRIORITY

This application is a non-provisional of and claims priority to Provisional Application No. 63/594,360, filed Oct. 30, 2023, which is incorporated herein by reference for all purposes.

A portion of the disclosure of this patent document contains material, which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND

This disclosure relates in general to allocating tickets for live events and, not by way of limitation, to an artificial intelligence (AI)-enabled system for allocating tickets for live events, among other things.

Several conventional e-commerce applications/websites present various options to a user when selecting/booking an item. However, the traditional process of manually filling up all the details, applying filters as needed, and repeating the entire process with a change in requirement leads to confusion and wasted time. Moreover, the entire user interface for booking the ticket is driven by the user, which may not guarantee that the user (i.e., attendee) receives their preferred seating arrangements, leading to dissatisfaction.

In recent years, technological advancements have made it possible to simplify the ticket booking process and improve the overall user experience for the users. However, even with a simplified ticket booking process, attendees still go through the time-consuming process of filling in details manually in different fields of the form and applying filters manually to get the desired results. Confusion results in less sales while leading to user dissatisfaction.

### SUMMARY

In one embodiment, the present disclosure provides one or more techniques that aims to eliminate the drawbacks of the traditional check-in process by introducing a new system to streamline the check-in process and to ensure that the attendees get their preferred seating arrangements without the need for physical check-in.

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Certain aspects and features of the present disclosure relate to a multi-modal e-commerce system for providing artificial intelligence (AI) based ticket booking to a plurality of users, comprising a system application running on a user device and an AI-enabled engine. The system application includes a hybrid interface, and the hybrid interface includes a first interface and a second interface. The first interface is configured to receive user input in natural language via a chatbot. The AI-enabled engine processes the user input to generate a searchable query and uses the searchable query from the user input as one or more keywords to identify a plurality of results. A textual output is generated in the natural language on the first interface based on the plurality of results; and a visual output is generated on the second interface based on the plurality of results. The plurality of results is based on user demographics, user preferences, and user feedback obtained from an event database. Other embodiments of this aspect include corresponding computer systems, apparatus, and computer programs recorded on one or more computer storage devices, each configured to perform the actions of the methods.

Certain embodiments of the present disclosure described herein relate to systems and methods that enhance and efficiently implement artificial intelligence (AI)-based recommendations to users for events. One embodiment of the present disclosure relates to a multi-modal e-commerce system for providing artificial intelligence (AI) based ticket booking to a plurality of users. The multi-modal e-commerce system includes a system application running on a user device and an AI-enabled engine. The system application includes a hybrid interface. The hybrid interface includes a first interface and a second interface. The first interface is configured to receive a user input in a natural language via a chatbot. The AI-enabled engine processes the user input to generate a searchable query. The AI-enabled engine is configured to use the searchable query from the user input as one or more keywords to identify a plurality of results. A textual output is generated in the natural language on the first interface based on the plurality of results. A visual output is generated on the second interface based on the plurality of results. The plurality of results are based on user demographics, user preferences, and user feedback obtained from an event database. Other embodiments of this aspect include corresponding computer systems, apparatus, and computer programs recorded on one or more computer storage devices, each configured to perform the actions of the methods.

Moreover, one general aspect includes the multi-modal e-commerce system includes the visual output on the second interface which is based on a text response generated based on the user input indicating access right information associated with an event, a visualization of the text response, a seat map displaying availability of access rights for the event, based on the input from the user, and in response to one or more filters obtained from the searchable query, a user interaction element, enabling selection of a number of access rights, and enabling selection of a value range for the number of access rights.

In one exemplary embodiment, a system of one or more computers is configured to execute specific operations through software, firmware, or hardware. This includes the access rights include one or more tickets for an event and the plurality of results include a plurality of events.

Further, in one exemplary embodiment, the AI-enabled engine is further configured to: determine a user intent from the user input, determine constraints, in response to the user intent, query a resource data store, based on the constraints, determine an availability of access rights, based on query results, expand constraints if access rights are unavailable, retrieve access right information, based on availability, generate a text response, based on the access right information, generate first interface data, based on a user input and text response, apply a first degree of visibility to the first interface data, generate a visual response, based on the access right information, generate second interface data, based on the visual response, apply a second degree of visibility to the second interface data, and present a hybrid interface on a user device, based on the first and second interface data, in response to the user input and applied filters.

Beyond the method, the textual output is a response from the searchable query including events in the natural language, and the visual output is a response from the searchable query including a visual form of the events and corresponding event information.

In one exemplary embodiment, the AI enabled engine is further configured to acquire real-time user feedback on the plurality of results and modify the set of results based on the user feedback.

Furthermore, the user demographics include user location, user data, and venue locations of events; user preferences include user information on seat, price, artist, genres, sub-genres, social media graph of user, browsing history, web searches associated with entities of multiple resources, likes, clicks, favorites, purchase history, tickets purchased, tickets transferred, tickets sold, attendance history, friends, friends list, items displayed, venue, price, venue location, median price in group, history; and user feedback include feedback from users for one or more events before and after attending the one or more events. Other embodiments of this aspect include corresponding computer systems, apparatus, and computer programs recorded on one or more computer storage devices, each configured to perform the actions of the methods.

Certain aspects and features of the present disclosure relate to a method for providing artificial intelligence (AI) based ticket booking to a plurality of users, the method comprising running a system application on a user device. The system application includes a hybrid interface, and the hybrid interface includes a first interface and a second interface. The first interface is configured to receive a user input in a natural language via a chatbot. The method further includes processing via an AI-enabled engine, the user input to generate a searchable query, using the searchable query by the AI-enabled engine from the user input as one or more keywords to identify a plurality of results, generating by the AI-enabled engine a textual output in the natural language on the first interface based on the plurality of results, and generating by the AI-enabled engine a visual output on the second interface based on the plurality of results, wherein the plurality of results are based on user demographics, user preferences, and user feedback obtained from an event database. Other embodiments of this aspect include corresponding computer systems, apparatus, and computer programs recorded on one or more computer storage devices, each configured to perform the actions of the methods.

Certain aspects and features of the present disclosure relate to a non-transitory computer-readable medium containing instructions that, when executed by a processor, cause the processor to perform a method for providing artificial intelligence (AI) based ticket booking to a plurality of users. The computer-readable media comprising running a system application on a user device. The system application includes a hybrid interface, and the hybrid interface includes a first interface and a second interface. The first interface is configured to receive a user input in a natural language via a chatbot, and process via an AI-enabled engine, the user input to generate a searchable query. The computer-readable media further comprising using the searchable query by the AI-enabled engine from the user input as one or more keywords to identify a plurality of results, generating by the AI-enabled engine a textual output in the natural language on the first interface based on the plurality of results, and generating by the AI-enabled engine a visual output on the second interface based on the plurality of results. The plurality of results are based on user demographics, user preferences, and user feedback obtained from an event database. Other embodiments of this aspect include corresponding computer systems, apparatus, and computer programs recorded on one or more computer storage devices, each configured to perform the actions of the methods.

### BRIEF DESCRIPTION OF THE DRAWINGS

The present disclosure is described in conjunction with the appended figures:

FIG. 1 illustrates a block diagram of a multi-modal e-commerce system according to an embodiment of the present disclosure;

FIG. 2 illustrates a block diagram of a user device and Application interface according to an embodiment of the present disclosure;

FIG. 3 illustrates a block diagram of a user device according to an embodiment of the present disclosure;

FIG. 4 illustrates a block diagram of components of a resource management system according to an embodiment of the present disclosure;

FIG. 5 illustrates a block diagram of a machine learning model according to an embodiment of the present disclosure;

FIG. 6 illustrates a block diagram of a model executor according to an embodiment of the present disclosure;

FIG. 7A illustrates an interface diagram of an application interface generated by a resource management system according to an embodiment of the present disclosure;

FIG. 7B illustrates an interface diagram a hybrid interface generated by a resource management system according to an embodiment of the present disclosure;

FIG. 8 illustrates a hybrid interface generated by a resource management system for presenting access right information according to an embodiment of the present disclosure;

FIG. 9A illustrates an interface diagram of a hybrid interface generated by a resource management system for initiating access right booking according to an embodiment of the present disclosure;

FIG. 9B illustrates an interface diagram of a hybrid interface generated by a resource management system according to an embodiment of the present disclosure;

FIG. 9C illustrates an interface diagram of a hybrid interface generated by a resource management system for requesting second additional information for requesting first additional information according to an embodiment of the present disclosure;

FIG. 9D illustrates an interface diagram of a hybrid interface generated by a resource management system for requesting value information and presenting confirmation for the assignment of access rights according to an embodiment of the present disclosure;

FIG. 10A illustrates an example embodiment of an interface diagram of a hybrid interface generated by a resource management system for requesting a user permission to provide personalized information according to an embodiment of the present disclosure;

FIG. 10B illustrates an example embodiment of an interface diagram of a hybrid interface generated by a resource management system for presenting personalized information and requesting confirmation for assignment of access rights according to an embodiment of the present disclosure;

FIG. 11 illustrates a flowchart for generating a hybrid interface according to an embodiment of the present disclosure;

FIG. 12 illustrates a flowchart for generating a hybrid interface according to an embodiment of the present disclosure;

FIG. 13A illustrates a flowchart for generating a hybrid interface for booking access rights to an event according to an embodiment of the present disclosure;

FIG. 13B illustrates a flowchart for allocating access rights to a user device based on an access right booking request according to an embodiment of the present disclosure;

FIG. 14 illustrates a flowchart for generating hybrid interfaces for booking access rights to an event according to an embodiment of the present disclosure;

FIG. 15 illustrates a flowchart for authenticating a user to access a system application associated with a resource management system according to an embodiment of the present disclosure;

FIG. 16 illustrates a flowchart for determining recommendations for a user based on user preferences and user patterns according to an embodiment of the present disclosure;

FIG. 17 illustrates a block diagram of a venue management device according to an embodiment of the present disclosure; and

FIG. 18 illustrates a block diagram of an end-user device according to an embodiment of the present disclosure.

In the appended figures, similar components and/or features may have the same reference label. Further, various components of the same type maybe distinguished by following the reference label with a second alphabetical label that distinguishes among the similar components. If only the first reference label is used in the specification, the description applies to any one of the similar components having the same first reference label irrespective of the second reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

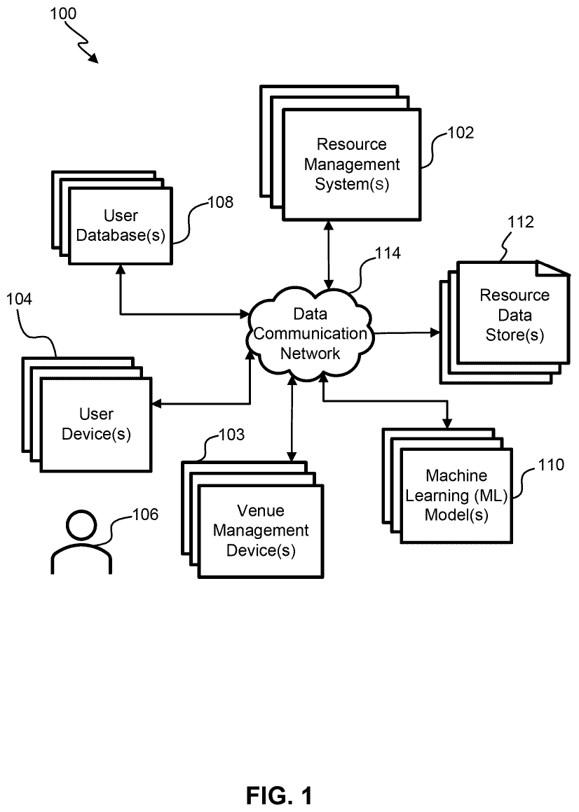

Referring to FIG. 1, illustrates a block diagram of a multi-modal e-commerce system 100, according to some embodiment of the present disclosure. The multi-modal e-commerce system 100 is for providing artificial intelligence (AI) based ticket booking to a plurality of users. The multi-modal e-commerce system 100 includes a resource management system(s) 102, a venue management device(s) 103, a user device(s) 104 associated with a user 106, a user database(s) 108, a machine learning model(s) 110, a resource data store(s) 112, and a data communication network 114. The multi-modal e-commerce system 100 provides a hybrid multi-modal ticket booking system where a hybrid interface, including two different interfaces, is displayed to the user 106 on a user device 104 for interaction.

In some configurations, the venue management device(s) 103 can be operated by one or more event providers hosting a live event at a venue. The venue management device(s) 103 can generate and/or transmit event related information and event-provider communication. The venue management device(s) 103 may be provided with the event related information by the venue management device(s) 103 or a third party/external server(s) (not shown). For example, the venue management device(s) 103 can send an event provider communication that indicates Location Y in New York for hosting a series of periods (e.g., a series of the play Hamilton on 10 particular nights).

In one embodiment, an individual location associated with a single series of periods is identified from the event provider communication. For example, the received event provider communication indicates an area of Location Y for hosting a single series of Hamilton shows between March 2018 and April 2018.

In another embodiment, the received event provider communication can indicate multiple locations associated with various series of periods. For example, the received event provider communication can indicate Location Y for hosting a series of Hamilton shows between March 2018 and April 2018 and the location Raleigh Arena in Raleigh, N.C., for hosting a series of Hamilton shows between June 2018 and July 2018. As can be seen, a series of periods can correspond to a series of events of a particular performance or show at a particular venue (e.g., location). In such an embodiment, each performance can occur at a particular location at a particular period.

The event providers use servers (not shown) or the venue management device(s) 103 to transmit tickets to users and receive purchase amounts for the tickets. The user may receive event ticket and venue information from the event provider via the servers (not shown) or a resource management system 102 or the venue management device(s) 103. The user can book tickets directly from the venue management device(s) 103. The resource management system 102 provides the ticket to the user on the user device 104 of the user after successful payment for the ticket. The user presents the ticket to a scanner (not shown), which identifies the ticket and presents the ticket to the resource management system 102 for user verification. The resource management system 102 authenticates the ticket provided by the scanner.

In an embodiment, the venue management device(s) 103 may request the server (not shown) or third-party servers (not shown) of the event providers to provide details of the ticket to match the details provided by the event providers with the details of the ticket provided by the scanner. The event providers may give the ticket details to the venue management device(s) 103 on receiving a request from the venue management device(s) 103. The venue management device(s) 103 match the details of the ticket provided by the scanner with the details provided by the event providers to authenticate the ticket credentials of the ticket user and authorize access to the user for entering the event.

In one exemplary embodiment of the present disclosure, the resource management system 102 is communicatively coupled with the venue management device(s) 103, the user device 104, a user database 108, a machine learning model 110, and a resource data store 112 over the data communication network 114. The user device 104 is connected to the resource management system 102 and the user database 108 over the data communication network 114.

In another embodiment, the resource management system 102 may be connected to the user device 104 and the user database 108 through an intermediate system. In another embodiment, the resource management system 102 may include at least one resource data store 112, the machine learning model 110, and the user database 108. In another embodiment, the user device 104 may include the user database 108. Please note that the specification is not limited to a single user device. It may communicate with multiple user devices either alternately or simultaneously. The user database 108 includes data from the resource data store 112, and the user database 108.

The resource management system 102 is configured to generate the hybrid interface on the user device 104 based on user input received from the user device 104. The hybrid interface may comprise a chat interface (CI) and a visual interface (VI). The chat interface presents text data indicating chatting with the user device 104.

The visual interface presents a visual response (VR) according to the chatting on the chat interface. The visual response provides a visualization of content to the user with the help of text and figures according to chatting between the resource management system 102 and the user device 104. To generate the hybrid interface, the resource management system 102 may execute the machine learning model 110 to determine the user intent of the user 106 associated with the user device 104. Additionally, the resource management system 102 translates the user intent into actionable commands through an application programming interface (API) layer.

Further, the resource management system 102 generates text data indicating the user input. Additionally, the resource management system 102 generates the VR based on the user intent determined from the user input. In addition, the resource management system 102 is configured to generate first interface data based on the text data generated to indicate the user input. Additionally, the resource management system 102 generates second interface data based on the VR generated based on the user intent.

Furthermore, the resource management system 102 adjusts the first interface data to be visible with a first degree of visibility and the second interface data to be visible with a second degree of visibility. The resource management system 102 generates the hybrid interface on the user device 104.

The hybrid interface is divided into the chat interface and the visual interface, where the content of the chat interface is presented based on the first interface data, and the content of the visual interface is presented based on the second interface data. In another embodiment, the resource management system 102 may generate a text response (TR) in response to the user input. In another embodiment, the resource management system 102 may generate the text response on the chat interface.

The user device 104 includes a system (web and/or mobile) application running thereon and associated with the resource management system 102. The user 106 may login into the system application to establish communication with the resource management system 102. The user device 104 may request credentials like a username and a password from the user 106 to provide login into the system application. Once, the user 106 logged in into the system application, the user 106 may start chatting with the resource management system 102.

To initiate the presentation of the hybrid interface in the system application, the user device 104 transmits the user input to the resource management system 102. In an embodiment, the user device 104 may directly or indirectly transmit the user data based on a signal received from the resource management system 102. Direct transmission from the user device 104 to the resource management system 102 indicates transmitting the user data, stored in an internal or external memory of the user device 104, to the resource management system 102. Indirect transmission from the user device 104 to the resource management system 102 indicates accessing the user database 108 by the user device 104 to transmit the user data to the resource management system 102. User data may comprise user-specific data as well as biometric information.

The user specific data may include, but not limited to, historical interactions with the resource management system 102, web searches associated with entities of multiple resources, and social media information of the user 106 associated with the entities. The user biometric information may include fingerprint scan, retina scan, user image, and the like. Examples of user device 104 are a desktop, a laptop, and mobile devices like smartphones, mobile phones, tablets, a wearable device, and/or other similar devices.

The user database 108 stores the user data associated with the resource management system 102. In other words, the user database 108 receives user-specific data and user biometric information from the user device 104 to store temporarily or permanently.

Additionally, user database 108 maintains the storage of credential information, such as usernames, public keys, etc., related to user 106 in association with resource management system 102. The user database 108 transmits the user data to the resource management system 102 in response to receiving a signal from the resource management system 102. In one embodiment, the user database 108 may serve as a central repository or cached data. Please note that the specification is not limited to storing user data from a single user device in the user database 108. The user database 108 may store user data associated with the multiple user devices that communicate with the resource management system 102. The user database 108 exchanges the user data and the information stored therein with the resource data store 112.

The machine learning model 110 uses machine learning algorithms to analyze and understand user input to determine user intent. The user input is a text or audio-based search or query. The machine learning model 110 transmits the result(s) of the determination to the resource management system 102.

In one exemplary embodiment, the machine learning model 110 is designed for ticket booking applications aimed at enhancing user experience and optimizing ticket allocation processes. The present disclosure provides a detailed framework describing the input types, processing techniques, and output formats, enabling seamless integration into various ticket booking platforms. The machine learning model 110 leverages advanced machine learning algorithms to transform input data, ensuring efficient and accurate ticket allocation while considering various constraints and preferences.

Moreover, the machine learning model 110 provides a significant advancement in ticket booking systems, yielding customer satisfaction and revenue generation for businesses.

In one exemplary embodiment of the present disclosure, the machine learning model 110 for ticket booking applications accepts various input types, including user demographics, user preferences, travel dates, destination choices, budget constraints, historical booking data, and real-time availability status. Additionally, contextual factors such as weather conditions, holidays, and special events can be integrated as inputs for a more personalized ticket allocation process. A variety of input types are stored in the resource data store 112.

The user demographics include a user location, user data and venue locations of events, while the user preferences include user. information on seat, price, artist, genres, sub-genres, social media graph of user, browsing history, web searches associated with entities of multiple resources, likes, clicks, favourites, purchase history, tickets purchased, tickets transferred, tickets sold, attendance history, friends, friends list, items displayed, venue, price, venue location, median price in group, history, and user feedback include feedback from users for one or more events before and after attending the one or more events. The user information is stored in the resource data store 112.

Moreover, in certain aspects of the present disclosure, the machine learning model 110 employs data transformation techniques upon receiving the input types and user information. The data transformation techniques include data normalization, feature engineering, and categorical variable encoding to prepare the input data for analysis. The machine learning model 110 utilizes algorithms to discern patterns within the input data, allowing for intelligent decision-making. Furthermore, natural language processing (NLP) techniques can be incorporated to understand user queries conversationally, enabling a user-friendly experience.

The resource data store 112 stores resource information, such as access right (AR) information for multiple events associated with the resources and event information. The resource may include events associated with an entity like a performer, an owner, an event manager, and the like. The access rights include one or more tickets for the event.

The resource data store 112 transmits the access correct information and/or the event information to the resource management system 102 according to a signal received from the resource management system 102. The access correct information for an event may include the availability of seats for the event, availability of parking slots in a venue, and availability of insurance schemes regarding the seats or the parking slots. The event information includes the location of the venue of the event, scheduled time of the event, entities like performers associated with the event, location, and names of restaurants and shopping malls around the venue of the event, etc.

The data communication network 114 provides a medium of transmission and reception of data among the resource management system 102, the user device 104, the user database 108, the machine learning model 110, and/or the resource data store 112.

Further, in one exemplary embodiment of the present disclosure, the output generated by the machine learning model 110 includes optimized ticket recommendations tailored to individual user preferences. These recommendations encompass various parameters such as suitable travel options, optimal routes, seat preferences, and pricing information. The output can be presented user-friendly, including interactive interfaces, graphical representations, and detailed textual descriptions, enhancing user engagement and understanding.

In one exemplary embodiment of the present disclosure, various machine learning models could be implemented to enable the ticket booking process described herein. The machine learning model 110 includes recommender systems, decision trees and random forests, neural networks, support vector machines (SVM), XGBoost, and gradient boosting machines, but not limited to these only.

In one exemplary embodiment, recommender systems such as collaborative filtering and content-based filtering, can be employed to suggest relevant travel options based on user preferences, and historical booking data. In certain aspects of the present disclosure, decision tree-based models like Random Forests are effective in handling complex decision-making processes. They can consider multiple factors simultaneously, making them ideal for optimizing ticket allocations based on various constraints.

In one exemplary embodiment of the present disclosure, deep learning models, particularly neural networks, can analyze vast amounts of data and learn intricate patterns. Further, recurrent neural networks (RNNs) can be utilized for processing sequential data, such as historical booking trends, to forecast future demands accurately.

In one exemplary embodiment of the present disclosure, the SVM models handle both classification and regression tasks. In the context of ticket booking applications, SVM can aid in classifying users into different segments based on their preferences, permitting for targeted ticket recommendations.

In one exemplary embodiment of the present disclosure, the XGBoost and gradient boosting machines are ensemble learning techniques that can optimize the model's performance by combining the strengths of multiple weak learners. The XGBoost and gradient boosting machines are useful in scenarios where high accuracy is pertinent, such as predicting ticket availability during peak seasons.

In one exemplary embodiment of the present disclosure, the machine learning model 110 encompasses various input types, including user preferences, travel details, historical data, real-time availability, and contextual factors. The machine learning model 110 employs data processing techniques such as data normalization, feature engineering, and natural language processing. It utilizes machine learning algorithms and techniques to analyse the transformed data, ensuring seamless ticket allocation and an enhanced user experience.

Moreover, the present disclosure employs recommender systems, including collaborative filtering and content-based filtering, to suggest relevant travel options based on user preferences. Decision tree-based models such as Random Forests handle complex decision-making processes, considering multiple factors to optimize ticket allocations. Neural networks, particularly recurrent neural networks (RNNs), analyse sequential data like booking trends for accurate demand forecasting. Support vector machines (SVM) classify users into segments based on preferences, enabling targeted recommendations.

The recommender systems, such as collaborative filtering and content-based filtering, suggest relevant travel options by discerning patterns from historical and user-specific data. The model's output includes personalized ticket recommendations, encompassing optimal routes, seat preferences, and pricing information, presented through intuitive and/or hybrid interfaces.

One exemplary embodiment of the present disclosure, a chat interface is integrated with artificial intelligence technology for ticket booking by receiving inputs from users in natural language form.

Further, the resource management system 102 for ticket booking comprises a chat interface facilitating natural language chat interaction with users via a chatbot. This interface incorporates distinct sections, including user identification, text-based input for event-related queries, interactive elements, and a visual response section for user-initiated event searches. User intent has been determined by analyzing user input from both chat and visual interfaces, discerning user intent, and translating it into actionable commands through an API layer.

Moreover, the resource management system 102 for ticket booking dynamically adjusts the visual interface based on the determined user intent, ensuring an adaptive and intuitive user experience. A display module prioritizes and produces dynamic visual responses aligned with user intent and applies adaptive visibility settings to interface elements, optimizing user interaction.

In one exemplary embodiment, users can now engage in voice conversations and visually interact with the ticket booking system, creating a seamless and intuitive interface. By enabling users to snap pictures of artists or events and initiating live conversations, the system empowers users to explore events in a more interactive manner.

Additionally, the voice feature facilitates on-the-go interactions, permitting users to inquire about ticket availability, book tickets for family events, and query upcoming events within specific budget constraints.

In one exemplary embodiment, these capabilities are accessible across various platforms, including Windows, iOS, and Android, ensuring widespread accessibility and usability. Moreover, the users can converse naturally with the system, request ticket bookings, and receive real-time responses. The chat interface, with unique sections and adaptive visibility settings thereof, provides a personalized and responsive user experience.

Furthermore, certain aspects of the present disclosure relate to the resource management system 102 for ticket booking that redefines the ticket booking experience, making the ticket booking engaging, intuitive, and user-friendly by combining natural language processing, visual interaction, and adaptive interface design.

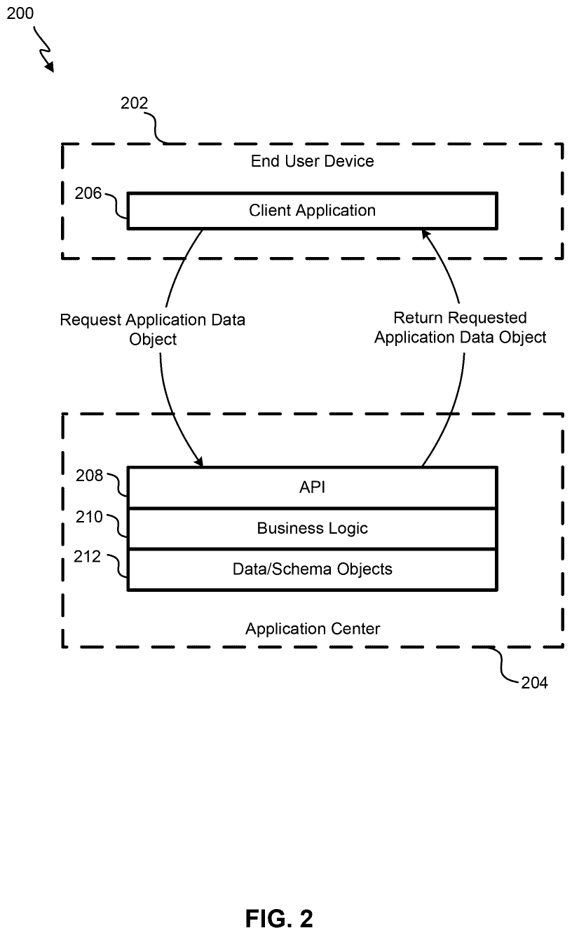

Referring to FIG. 2, illustrates a block diagram 200 of a user device and an application interface, embedded with a system and/or apparatus, for access rights booking and group check-in. In one embodiment, the block diagram 200 includes an end-user device 202 and an application center 204 which are in communicatively coupled amongst one another. The end-user device 202 is the user device 104. In some embodiments, the end-user device 202 includes a client application 206 such that the client application 206 requests application data objects from the application center 204. Further, the application center 204 includes an application program interface (API) 208, a business logic 210, and data/schema objects 212 for performing various operations on data before transmitting data back to the client application.

In some embodiments, client application 206 is downloaded from application center 204 and then installed on the end-user device 202. The client application 206, upon execution on the end-user device 202, provides various features and options for access rights booking and group check-in which are described in more detail with reference to the subsequent drawings.

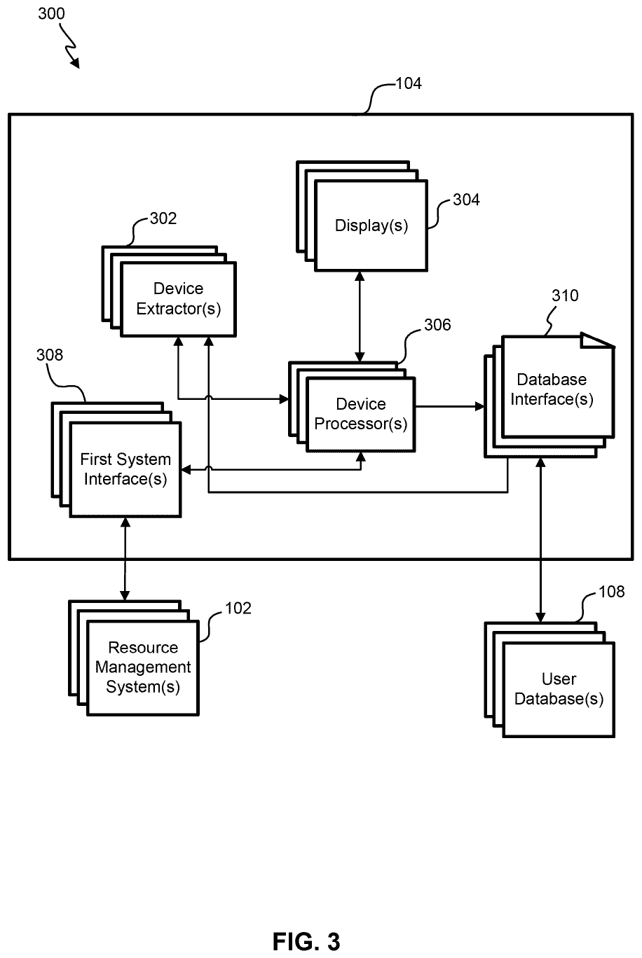

Referring to FIG. 3, illustrates a block diagram 300 of the user device 104 according to an embodiment of the present disclosure. The user device 104 comprises components like a device extractor(s) 302, a display(s) 304, device processor(s) 306, a first system interface(s) 308, and a database interface(s) 310.

The device processors 306 are connected with the other components like the device extractor 302, the display 304, the first system interface 308, and the database interface 310. Additionally, the device extractor 302 is connected with the database interface 310 to receive information from the user database 108.

The device extractor 302 is configured to extract the user data from the user database 108. Further, the device extractor 302 transmits the extracted user data to the device processors 306. In an embodiment, the device extractor 302 receives a signal from the device processors 306 to transmit extracted data to the device processors 306 for further processing.

The display 304 displays a hybrid interface on the user device 104. The display 304 receives a signal from device processors 306 to update the user interface. Additionally, the display is controlled by device processors 306 to determine the degree of visibility of the hybrid interface.

The device processors 306 are configured to control other components like the device extractor 302, the display 304, the first system interface 308, and the database interface 310. The device processors 306 receive data from other components of the user device 104, process the data, and transmit a control signal to the other components based on the processing. The device processors 306 are enabled by the resource management system 102 based on a signal transmitted from the resource management system 102. The device processors 306 provide the user data extracted from the user database 108 to the resource management system 102, and the resource data store 112 for further processing based on the signal received from the resource management system 102, and the resource data store 112, respectively.

The first system interface 308 functions as an application programming interface (API) to exchange communications between the user device 104 and the resource management system 102. The database interface 310 functions as an application programming interface (API) to exchange communications between the user device 104 and the user database 108.

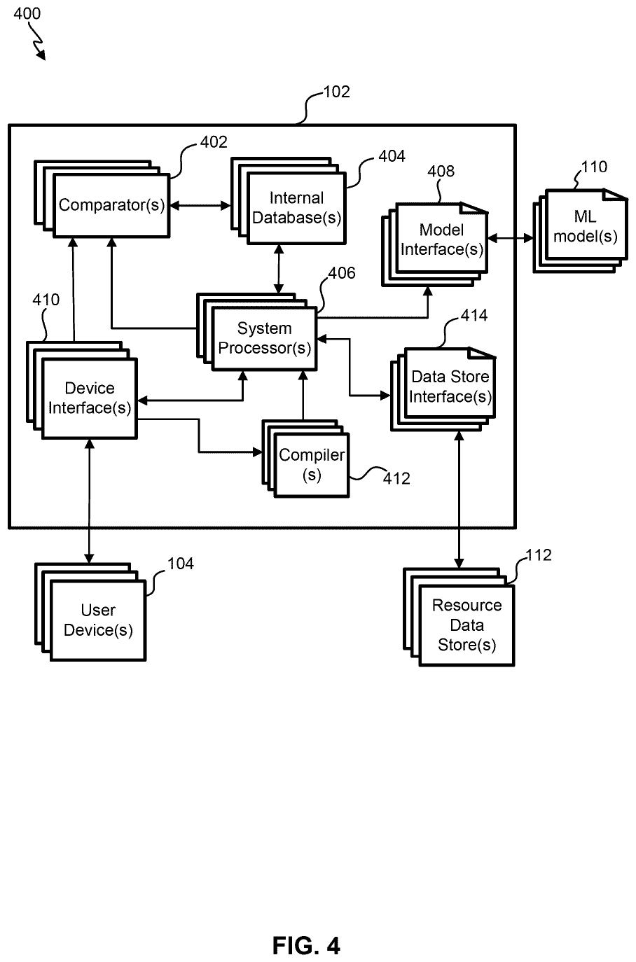

Referring to FIG. 4, a block diagram of components 400 of the resource management system(s) 102 is shown according to an embodiment of the present disclosure. The resource management system(s) 102 is configured to generate a hybrid interface on the user device(s) 104 based on a user input received from the user device(s) 104. The hybrid interface may comprise a chat interface (CI) and a visual interface (VI). The chat interface presents text data indicating chatting with the user device 104, and the visual interface presents visual data indicating results based on the user input. The results include events. The results are determined using the machine learning model(s) 110.

The resource management system 102 comprises a comparator 402, an internal database 404, system processors 406, a model interface 408, a device interface 410, a compiler 412, and a data store interface 414. The user 106 uses the interface on the user device 104 to provide user credentials to the system processors 406 in order to use the system application of the multi-modal e-commerce system 100.

The comparator 402 is configured to compare user credentials received from the user device 104 with pre-stored user credentials stored in the internal database 404. If the received user credentials match with the pre-stored user credentials, then the user 106 is permitted to log in to the system application associated with the resource management system 102.

The internal database 404 is configured to store the user credentials at the time of registration of the user 106 in the system application. The system processors 406 may update stored user credentials in response to the user request or any unauthorized login which is not done by the user 106.

In one exemplary embodiment, the unauthorized login may refer to a login done on a device other than the user device 104. In that case, the resource management system 102 transmits a notification to the user device 104 to confirm that the login into another device is done by the user 106. The user credentials stored in the internal database 404 may be updated when the user 106 confirms that the login is not done by the user 106 in response to the notification.

The system processors 406 are configured to control the overall function of the resource management system 102. The system processors 406 are communicatively coupled to other components like the comparator 402, the internal database 404, the model interface 408, the device interface 410, the compiler 412, and the data store interface 414.

Further, the system processors 406 receives a comparison result from the comparator 402. The comparison result is analyzed by the system processors 406 to determine whether the user 106 should be provided access to login in the system application. Additionally, the system processors 406 activate the model interface 408 to receive a machine learning result from the machine learning model 110. Further, the system processors 406 activates the device interface 410 to receive the user data from the user database 108.

In addition, the system processors 406 activate the data store interface 414 to receive the resource information from the resource data store 112. The resource information includes access right (AR) information to multiple events associated with the resources and event information. The resource may include events associated with an entity, such as a performer, an owner, an event manager, etc. In addition, the system processors 406 activate the device interface 410 to receive the user input or the user data from the user device 104. Components of the resource management system 102, like the model interface 408, the device interface 410, and the data store interface 414, are activated by the system processors 406 by the transmission of an activation signal from the system processors 406 to the respective component. Additionally, the system processors 406 receive a result from the compiler 412 to determine user intent from the user input.

The model interface 408 is configured to retrieve the machine learning result from the machine learning model 110 and transmit the machine learning result to the system processors 406 based on an activation signal received by the system processors 406. The device interface 410 is configured to receive the user input and the user data from the user device 104 and transmit to the system processors 406 based on an activation signal received by the system processors 406.

The compiler 412 is configured to receive the user input from the device interface 410 in a natural language and convert the natural language into a machine level language, which is executable by the system processors 406. The data store interface 414 is configured to retrieve the resource information from the resource data store 112 and transmit to the system processors 406 based on an activation signal received by the system processors 406.

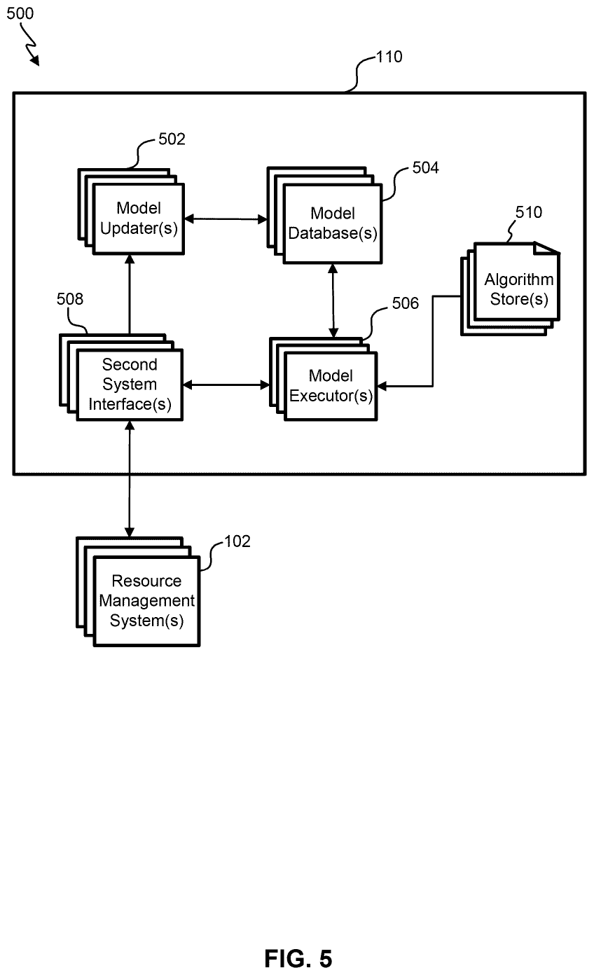

Referring next to FIG. 5, a block diagram 500 of the machine learning model(s) 110 is shown according to an embodiment of the present disclosure. The machine learning model(s) 110 includes a model updater(s) 502, a model database(s) 504, a model executor(s) 506, a second system interface(s) 508, and an algorithm store(s) 510. The model updater(s) 502 updates the machine learning model(s) 110 based on feedback data associated with the machine learning result received by the resource management system(s) 102.

In one exemplary embodiment of the present disclosure, the machine learning model 110 uses neural networks like convolutional neural networks (CNNs), recurrent neural networks (RNNs), and the like to determine the intent of the user 106 based on the user input. The feedback data indicates the efficiency of the determination of the user intent. Based on the feedback data, the model updater 502 accesses the model database 504 to update a neuron weight of the neural network to increase the efficiency of the machine learning model 110.

The model database 504 stores neural networks, weights of neurons for the neural networks, input data for the neural networks, output data from the neural networks, and the like. The model database 504 transmits the stored data to the model updater 502 and receives the updated data from the model updater 502 for storage. Additionally, the model database 504 transmits a neural network from the stored neural networks to the model executor 506, which executes the neural network.

The model executor 506 executes the neural networks stored in the model database 504 based on instruction data received from the resource management system 102. In an embodiment, the model executor 506 executes the neural network to determine user intent based on the user input. In another embodiment, the model executor 506 executes the neural network to determine the availability of access rights associated with the access right information based on the user intent.

The user input is received from the user via the resource management system 102. The user input includes a search query in a natural language. The user input may also include selections of filters or options on the user interface. User patterns, including past user browser history, purchase and booking history, user feedback, user preferences, and user specific data are extracted from the user database 108 and the resource data store 112.

Further, the instruction data is received from the resource management system 102 for the selection of a machine learning algorithm from the algorithm store 510 and the selection of a neural network from the model database 504. The machine learning algorithm determines the user intent based on the user input and the user patterns. For example, a user searches “Stevie Nicks concert in Chicago”.

The user intent is identified as searching for events related to Stevie Nicks in Chicago. Apart from finding the relevant events or concerts of Stevie Nicks in Chicago, the machine learning algorithm also identifies events based on user's schedule like weekends, holidays, etc. Further, the user preferences like seating arrangement, food, or parking, are also provided with the events. If the concerts of Stevie Nicks are not in Chicago but in places near Chicago, the events are displayed to the user, or concerts of other singers or rockstars in Chicago are displayed to the user.

The second system interface 508 receives the feedback data from the resource management system 102 and transmits the feedback data to the model updater 502. Additionally, the second system interface 508 receives the instruction data from the resource management system 102 and transmits the instruction data to the model executor 506.

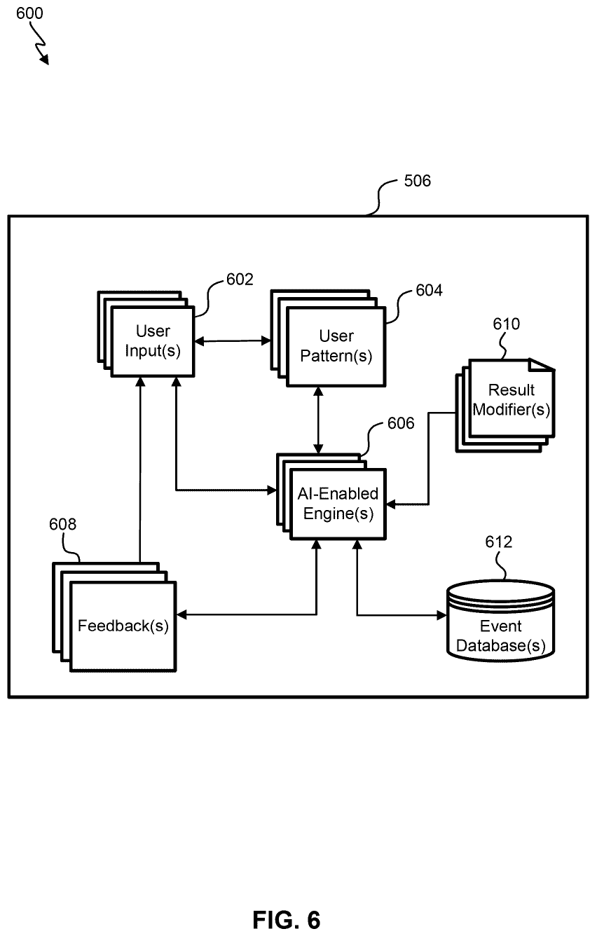

Referring next to FIG. 6, a block diagram 600 of the model executor(s) 506 according to an embodiment of the present disclosure is shown. The model executor 506 generates a user intent based on the user input. The user intent is determined based on user requirement, user feedback, user preferences, and user search query. The user intent is generated to calculate a set of results displayed to the user on the user device 106. The set of results includes a list of events that the user intends to search or book tickets for. The model executor(s) 506 includes a user input(s) 602, user patterns 604, an Artificial Intelligence (AI)-enabled engine(s) 606, feedback(s) 608, a result modifier(s) 610, and an event database(s) 612.

The user input 602 includes a search query entered by the user either verbally/orally through a microphone or entered as a text in the search tab on the user interface of the user device 104. The search query is in natural language and is provided to the AI-enabled engine 606. The AI-enabled engine 606 processes the user input provided as the search query to generate a searchable query in terms of keywords.

The AI-enabled engine 606 includes one or more parsers that break the search query into keywords that can be used to search the event database 612. The event database 612 exchanges data to/from the user database 108 and the resource data store 112 of the multi-modal e-commerce system 100. The event database 612 includes a list of events occurring in a geographical area obtained from the various search engines, event providers and external databases. The AI-enabled engine 606 includes machine learning models including NLP engines process the search query in natural language and transform the search query into searchable keywords. The AI-enabled engine 606 uses the searchable query from the user input as one or more keywords to identify a plurality of results.

The AI-enabled engine 606 identifies a set of events as the plurality of results from the event database 612 based on the keywords of the search query provided by the user. The AI-enabled engine 606 generates a textual output in the natural language on the chat interface or the first interface based on the plurality of results. The set of events is further modified based on the user patterns 604. The user patterns 604 include past purchase history, browsing history, and user preferences of the user. If the user is a registered user and has purchased tickets for an event or browsed events in the past on the system application of the multi-modal e-commerce system 100, the user's activities and user data are stored in the user database 106.

The AI-enabled engine 606 determines the user intent from the user input and, in response to the user intent, determines constraints. The AI-enabled engine 606 queries the resource data store 112 based on the constraints. The AI-enabled engine 606 determines availability of access rights based on query results. The constraints are expanded if the access rights are unavailable. Access right information is retrieved based on availability of the access right information. A text response is generated based on the access right information. First interface data is generated based on the user input and text response. A first degree of visibility is applied to the first interface data. A visual response is generated based on the access right information to further generate second interface data based on the visual response. A second degree of visibility is applied to the second interface data. The hybrid interface is displayed on the user device 104 based on the first and second interface data, in response to the user input and applied filters. The textual output is a response from the searchable query including events in the natural language, and the visual output is a response from the searchable query including a visual form of the events and corresponding event information.

The user demographics include user location, user data, and venue locations of events; the user preferences include user information on seat, price, artist, genres, sub-genres, social media graph of user, browsing history, web searches associated with entities of multiple resources, likes, clicks, favorites, purchase history, tickets purchased, tickets transferred, tickets sold, attendance history, friends, friends list, items displayed, venue, venue location, median price in group, and history; and the user feedback includes feedback from users for one or more events before and after attending the one or more events.

The user data includes username, account details, social media profile, and the user preferences like food, parking, seating, or artist. The user patterns 604 acquire and store the user data and the user activities from the user database 106. The user data also includes upcoming work schedules of the user in order to suggest the events accordingly. The user data takes into consideration the friends and family preferences of the user based on their social gatherings, parties, trips, and get-togethers. For example, the user is expected to be on leave on Wednesday, and two friends and the user's wife can also take time off in the evening, so a dinner along with the event is recommended to the user. Further, the user prefers parking and front seating arrangement with Italian food as the user preferences acquired from the previous events attended by the user. The events from the user database 106 are filtered based on the user preferences to generate a filtered set of events for the user. The set of filtered events is displayed to the user on the user device 106.

The user may provide feedback in terms of selections of filters like price, days, or location. The user may also provide feedback verbally or via text via the user interface on the user device 104. The feedback is provided from the user on the user interface which is sent to the feedback 608 by the resource management system 102. The resource management system 102 receives the feedback from the user via the user interface.

The result modifier 610 uses the feedback to modify the set of results and generate a modified set of results based on the feedback received from the user. The modified set of results is presented to the user on the user device 106. The user may further provide updates or feedback which is updated in real-time in the feedback 608 and accordingly the results/events are modified. The set of results and the modified set of results displayed to the user include recommendations in text or visual also indicating a reason for displaying the particular event to the user. For example, Event A includes text saying that “the Event A is at your preferred location “Chicago” of one of your favorite artists “Stevie Nicks”, the parking, front seating and Italian cuisine is available. You may join the Event A with your friends and family or single on the coming Wednesday as you are on leave”.

A visual output is displayed to the user based on the user input which is updated based on the feedback from the user. The visual output is displayed on the second interface. The visual output on the second interface is based on the plurality of results. The plurality of results is based on user demographics, user preferences, and user feedback obtained from an event database. The plurality of results are updated based on the feedback from the user.

The visual output is the visual output on the second interface is based on a text output, generated based on the user input, indicating access right information associated with an event; a visualization of the text output; and a seat map displaying availability of access rights for the event based on an input from a user. In response to one or more filters obtained from the searchable query, a user interaction element, a selection of a number of access rights and a selection of a value range for the number of access rights are enabled.

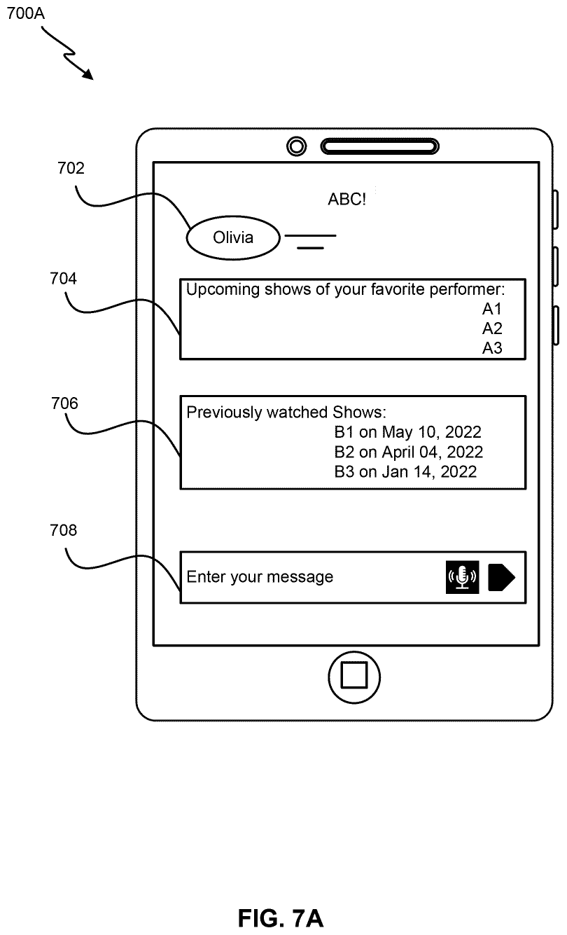

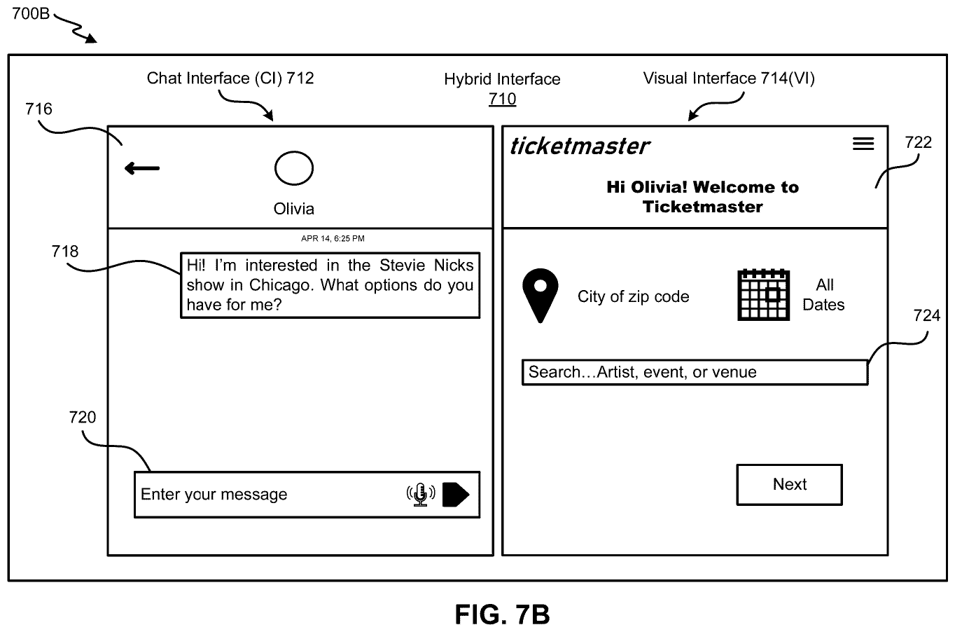

Referring next to FIG. 7A, an interface diagram 700A of an application interface generated by the resource management system 102 according to an embodiment of the present disclosure is shown. The application interface is an interface of the system application associated with the resource management system 102.

The application interface may be presented on the display 304 of the user device 104 based on a user input on an icon of the system application. The user 106 may use the user credentials to login into the system application. Once the user 106 logs in into the system application, the application interface may be presented on the user device 104.

Further, the application interface includes an element 702, an element 704, an element 706, and an element 708. The element 702 indicates the identification of the user 106. The user 106 may edit profile details by providing user input on element 702. Element 704 indicates suggestions for future events associated with one or more entities.

Moreover, the resource management system 102 may use the profile information provided by the user 106 at the time of registration in the system application or the user specific data such as the historical interaction of the user 106 with the system application for generating the suggestions. The element 706 indicates previous events associated with one or more entities that user attended in the past. The element 708 indicates a user interaction element through which the user 106 is permitted to provide the user input as a text input or an audio input.

Referring next to FIG. 7B, an interface diagram 700B of a hybrid interface 710 generated by the resource management system 102 according to an embodiment of the present disclosure is shown. The hybrid interface 710 may be generated on the display 304 of the user device 104 based on the user input provided on element 708 as shown in FIG. 7A. The hybrid interface 710 is divided into the chat interface (CI) 712 and the visual interface (VI) 714. The chat interface 712 includes an upper portion indicating user identification, a text-based input section for receiving user queries related to events, and a lower portion containing user interaction elements. The visual interface 714 provides real-time visual outputs in response to ongoing chat interactions on the chat interface 712.

The hybrid interface 710 includes the chat interface 712 and the visual interface 714, that further includes a visual response. The element 716 indicates the upper portion of the chat interface 712, which includes the identification of the user 106. The text-based input section of the chat interface 712 includes text data generated to indicate the user input or in response to the user input. For example, element 718 includes text data indicating the user input. The text data corresponding to element 718 includes a query associated with an event of the plurality of events. For example, the “Stevie Nicks show” may be called an event associated with an entity such as a performer “Stevie Nicks”. The element 720 indicates the lower portion of the chat interface 712 which includes the user interaction elements like a user interface for receiving text or audio inputs from the user 106.

Furthermore, the user interaction elements enable the user 106 to provide the user input in a text format or audio format. The visual response 722 is displayed on the visual interface 714. The visual response 722 is generated based on the user intent determined from the user input indicated by the text data corresponding to element 718. The visual response 722 provides information related to the event. In addition to that, the visual response 722 includes an element 724 which enables the user 106 to search other events associated with the performer “Stevie Nicks” on the visual response 722.

In one exemplary embodiment of the present disclosure, users can interact naturally in text or audio, and the system responds with real-time visual information, enhancing user experience, improving user engagement, efficient event discovery, and convenience. The system provides seamless integration of a chat-based interface and a visual interface 714 for ticket booking.

In one another exemplary embodiment of the present disclosure, the automatic conversion of audio user input into text, enables users to speak their requests in natural language. This system provides improved accessibility and usability, catering to users who prefer voice input.

In another exemplary embodiment of the present disclosure, the determination of user intent from chat interactions leads to context-aware visual responses. The system can display relevant event information and even suggest related events, enhancing user engagement and satisfaction.

In another exemplary embodiment of the present disclosure, the adjustment of interface visibility is based on user interactions. The interface includes a chat interface 712 and a visual interface 714 which offers a less intrusive user experience while maintaining information accessibility. This results in reduced distraction during chat interactions and improved readability of visual responses.

In another exemplary embodiment of the present disclosure, users can query, interact, and explore events efficiently on a single user-friendly ticket booking platform that presents a hybrid interface which is a combination of chat and visual elements.

In another exemplary embodiment of the present disclosure, the dynamic adaptation of the system's behavior based on the user's interaction patterns and intent results in intelligently prioritizing and adjusting the visibility of interface elements to adjust the user experience. Thus, resulting in a highly personalized and efficient ticket booking platform.

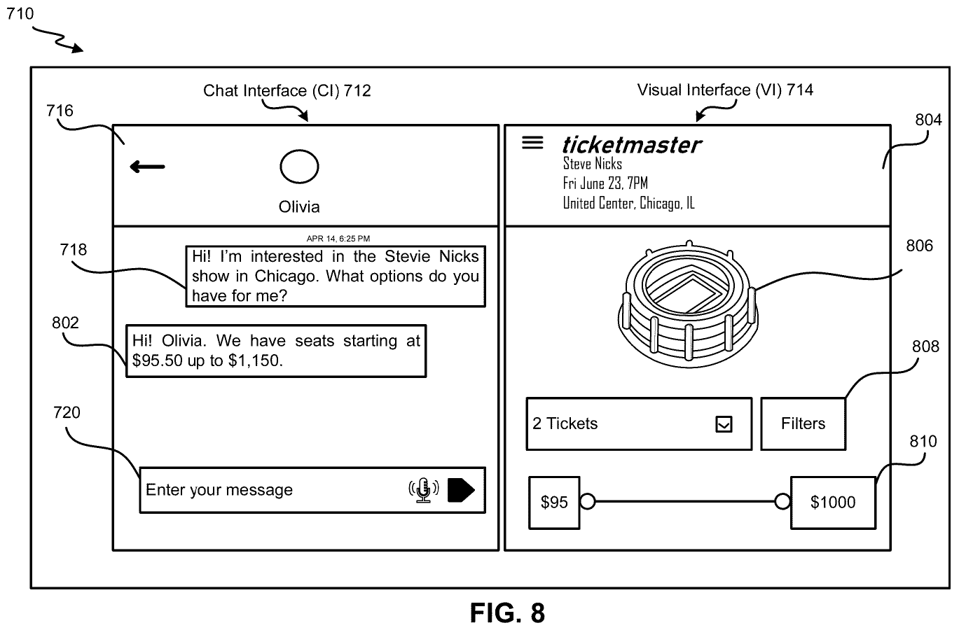

Referring next to FIG. 8, the hybrid interface 710 generated by the resource management system 102 for presenting access right information according to an embodiment of the present disclosure is shown. In addition to the elements shown in FIG. 7B, the hybrid interface 710 further comprises an element 802, an element 804, an element 806, an element 808, and an element 810. Element 802 is displayed on the chat interface 712 including a text response generated based on the user input indicated by the text data corresponding to element 718.

The text response corresponding to the element 802 indicates first access right information associated with the event generated in response to the text data corresponding to the element 718. The first access right information includes information of first access rights for the event. The first access rights may correspond to access rights for seats in the event.

Additionally, according to the text response corresponding to element 802, the visual response 722 of FIG. 7B is updated to a visual response corresponding to the element 704. The visual response corresponding to the element 704 will be referred hereinafter as a visual response 804. The visual response 804 provides a visualization of the text response to the user 106.

The visual response 804 consists of an element 806, the element 808, and the element 810. The element 806 indicates a seat map showing the availability of the first access rights for the event. The element 808 is a user interaction element that enables the user 106 to select a number of the first access rights. The element 808 is a user interaction element that enables the user 106 to select a value range for the first access rights.

In one exemplary embodiment of the present disclosure, the machine learning model 110 is designed to process user input to generate meaningful data for enhancing search query experiences. The machine learning model 110 employs artificial intelligence algorithms to transform raw user input into relevant and insightful information, thereby improving the quality of search results. Further, the machine learning model 110 is configured to perform several key functions, including the application of meaningful data as diverse filters for search queries based on the user input.

In one exemplary embodiment, the machine learning model 110 is adapted to generate meaningful data from the user input. Moreover, when a user submits a search query or provides input through various means, the machine learning model 110 processes the user input using natural language processing (NLP) techniques and semantic analysis. By determining the context, intent, and relevance of the user input, the system identifies and extracts crucial information, transforming it into meaningful data. These data points can include specific keywords, entities, categories, or even user preferences, which enhance the search query's depth and accuracy.

In one exemplary embodiment of the present disclosure, the system identifies keywords from user input, determining the primary focus of the query. For instance, in the input “latest smartphone models,” the keywords identified could be “latest,” “smartphone,” and “models,” which serve as one or more filters for refining search results.

Further, when the user mentions specific entities such as product names, locations, or individuals, the system recognizes these entities and categorizes them. For instance, in the user input “restaurants in New York,” the system identifies “restaurants” as the category and “New York” as the location, enabling precise search result filtering.

In one exemplary embodiment of the present disclosure, the machine learning model 110 can generate meaningful data about user inclinations by analysing past user interactions and preferences. For example, if a user frequently searches for tech-related topics, the system understands this preference and tailors search results, providing a personalized and meaningful user experience.

Furthermore, understanding the context of the user input is important. For instance, in the query “best travel destinations,” the system discerns the context as travel-related. It generates meaningful data about popular travel destinations, ensuring the search results align with the user's intent. By applying this meaningful data as one or more filters for search queries, the machine learning model 110 delivers highly relevant and accurate results. Subsequently, the machine learning model 110 generates output in natural language on the first interface, providing users with comprehensible and contextually appropriate responses, thereby significantly enhancing user experience and interaction with the search platform.

In one exemplary embodiment of the present disclosure, the machine learning model 110 is adapted to understand user intent, determine constraints, query relevant data, and provide a seamless interface experience based on the user input and one or more filters.

Moreover, upon receiving user input, the machine learning model 110 applies machine learning algorithms to determine the user's intent. By analyzing the input context, keywords, and entities, the system discerns the user's purpose, such as seeking information, making a reservation, and finding specific products. Accordingly, the machine learning model 110 identifies constraints relevant to the user's intent. In one exemplary embodiment of the present disclosure, the constraints include parameters such as location, time, budget, or user preferences, which refine the search parameters and develop the relevance of query results.

In one exemplary embodiment of the present disclosure, for a user input like “top-rated restaurants in London,” the system queries the resource data store 112 for restaurants matching the specified criteria. In addition, the query results could include a list of restaurants with ratings, reviews, and relevant details, providing the user with valuable information to make an informed decision.

Further, when a user searches for “flights to New York under $500,” the system recognizes the constraints as the destination (New York), budget (under $500), and travel time. These constraints guide the machine learning model 110 to query the resource data store 112 for flight options that meet the specified criteria, ensuring the user receives tailored and relevant results.

In addition, upon determining the query results and constraints, the machine learning model 110 assesses the availability of access rights. If access rights are unavailable, the machine learning model 110 dynamically expands the constraints or modifies the search parameters based on the user's permissions. Access correct information, including user privileges and restrictions, is retrieved and analyzed.

In one exemplary embodiment of the present disclosure, the machine learning model 110 creates the first interface data using the user input and the generated text response. For instance, if the user inquiries about “upcoming movie releases,” the first interface data can include movie titles, release dates, and brief descriptions, presented in a user-friendly format.

In addition, the resource management system 102 generates the second interface data based on the visual response 804 obtained from the resource data store 112. In the context of booking concert tickets, the second interface data may include seating charts, ticket availability, and prices. This data is presented visually to aid user engagement and decision-making.

In one exemplary embodiment of the present disclosure, the resource management system 102 applies degrees of visibility to the first and second interface data, ensuring that sensitive information is appropriately restricted based on the user's access rights. By integrating the first and second interface data, the system presents a hybrid interface 710 on the user device 104. The hybrid interface 710 seamlessly combines textual and visual elements, offering a comprehensive and personalized user experience based on the user input and the one or more filters. The hybrid interface 710 on the user device 104 is displayed based on the first and second interface data, in response to the user input and applied filters.

The resulting interface provides a dynamic, interactive, and contextually relevant platform, elevating user interactions in various domains, including e-commerce, travel, entertainment, and information retrieval.

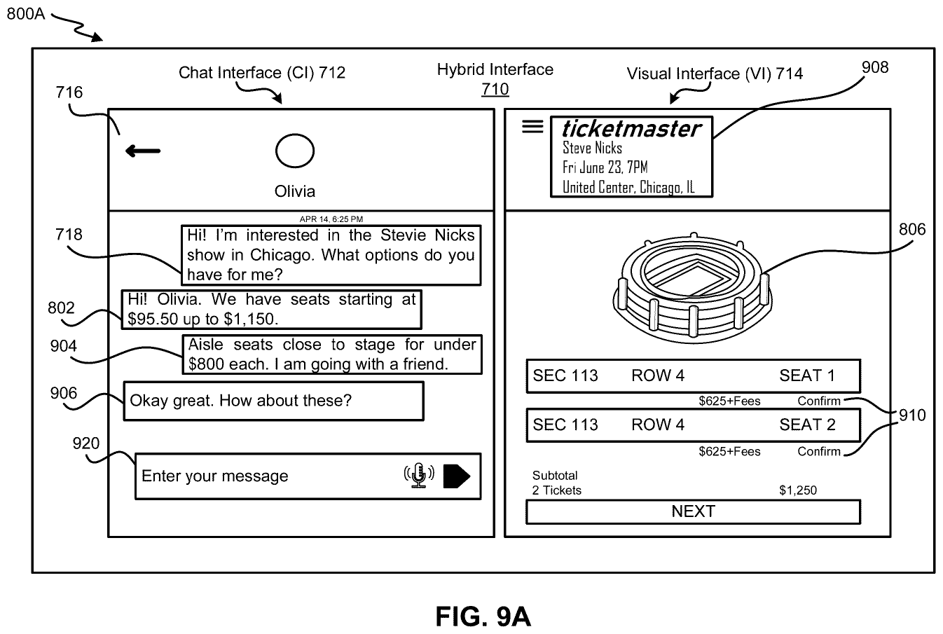

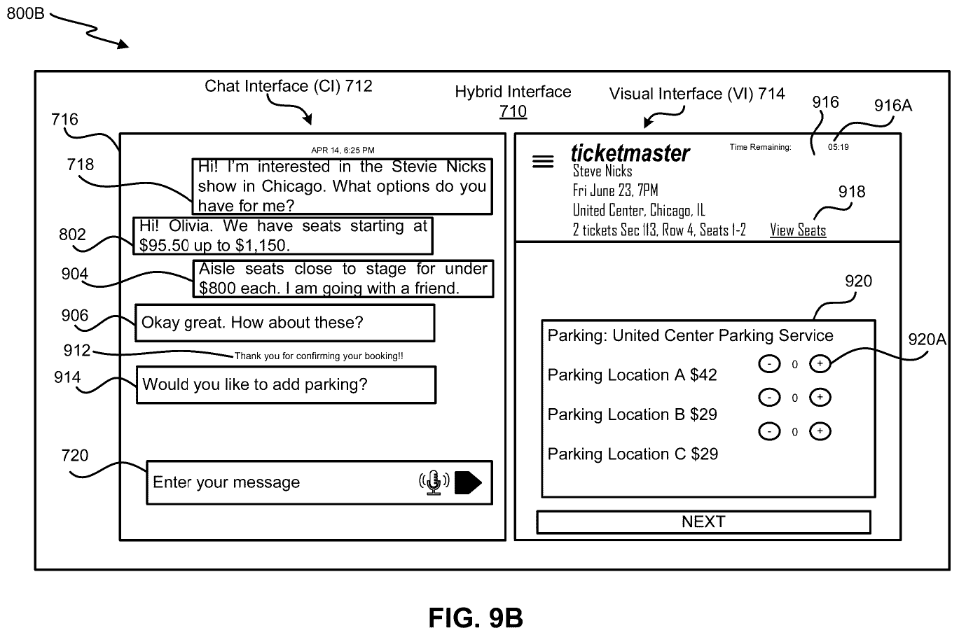

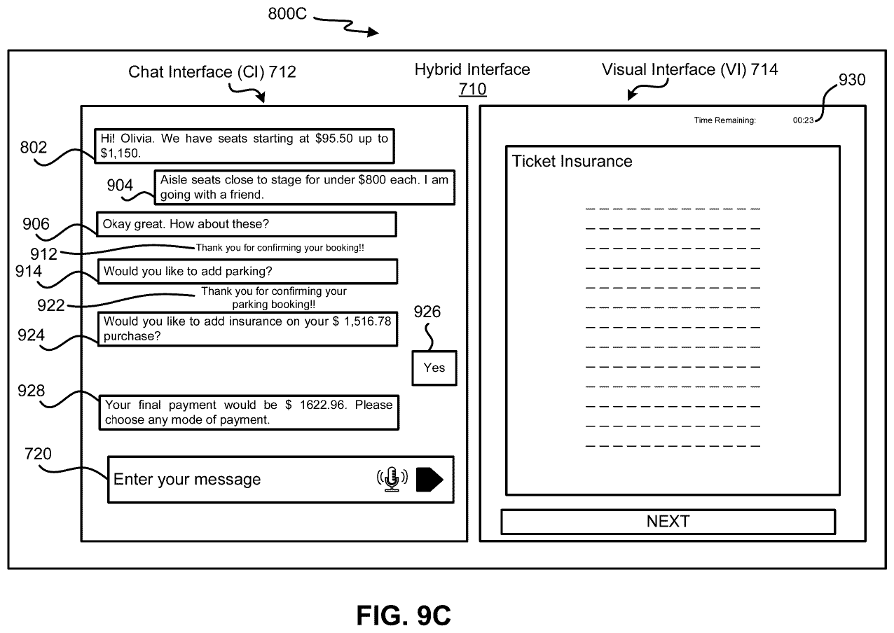

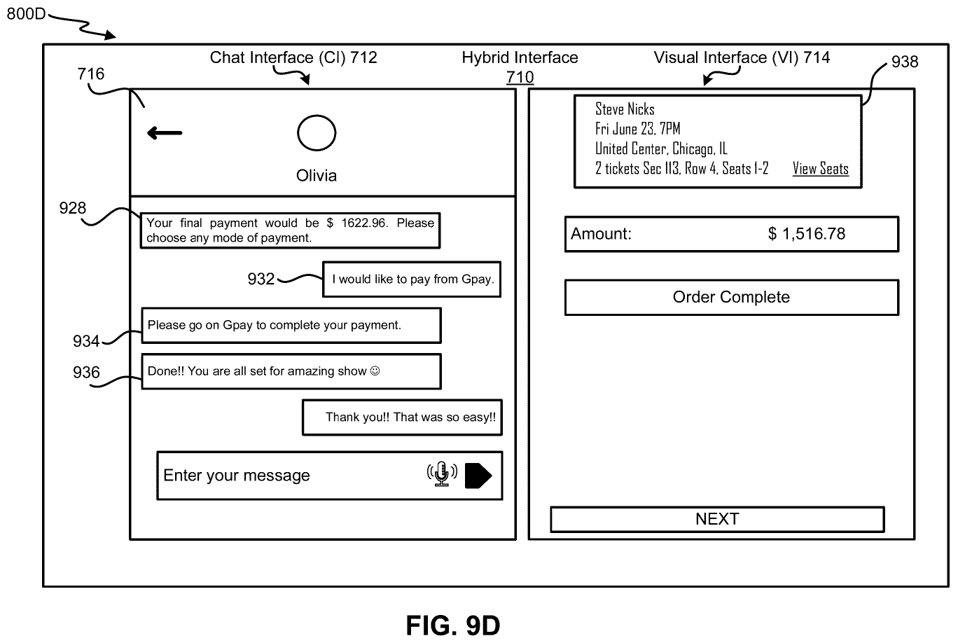

Referring next to FIG. 9A, an interface diagram 800A of the hybrid interface 710 generated by the resource management system 102 for initiating access right booking according to an embodiment of the present disclosure is shown. Besides the elements shown in FIG. 8, the hybrid interface 710 comprises an element 802, an element 804, an element 806, an element 808, and an element 810. The element 802 includes text data indicating a query to the user 106 for providing a user preference for the booking of the first access rights.

The element 904 is displayed on the chat interface 712 in response to the text data corresponding to the element 802. The element 904 includes text data corresponding to user input received for booking of the first access rights for the event. Further, the element 906 includes a text response in response to the user input indicated by the text data corresponding to the element 904.

Additionally, according to the text response corresponding to element 906, the visual response 804 of FIG. 8 is updated to a visual response corresponding to the element 808. The visual response corresponding to the element 808 will be referred to hereinafter as a visual response 908. The resource management system 102 retrieves first access right information according to the user preference determined from the user input indicated by the text data corresponding to the element 904.

The visual response 908 provides the first access right information on the visual interface. In other words, the visual response 908 provides a plurality of options of availability of one or more first access rights based on user preference. The text response corresponding to element 906 indicates a reference to the plurality of options displayed on the visual response 908.

Further, the visual response 908 includes the element 910. Element 910 indicates user interaction elements to confirm an option from the plurality of options for booking the first access rights. The user 106 may provide user input on the user interaction element for the selection of the first access rights. Please note that here only two options of the first access rights are shown in FIG. 9A. However, the visual interface 908 may display more than the two options.

Referring next to FIG. 9B, an interface diagram 800B of the hybrid interface 710 generated by the resource management system 102 for requesting first additional information according to an embodiment of the present disclosure is shown. Other than the elements shown in FIG. 9A, the hybrid interface 710 comprises an element 912, an element 914, an element 916, an element 916A, an element 918, an element 920, and an element 920 A.

The element 912 displayed on the chat interface 712 including text data indicating confirmation of selection of one or more of the plurality of options for the first access rights based on the user input received on the visual interface 714. The selection of multiple options for the first access rights may book the first access rights for a hold period indicated by the element 916A. During the hold period, the resource management system 102 waits for value information to be received from the user device 104. The resource management system 102 may not assign the booked first access rights after the expiration of the hold period.

In one embodiment, the duration of the hold period may depend on a load of requests for the first access rights for the event received from the plurality of user devices. In another embodiment, the duration of the hold period may depend on the affinity of the user 106 towards the entity associated with the event.

In one exemplary embodiment of the present disclosure, the duration of the hold period may depend on a weighted combination of the load of requests for the first access rights and the affinity towards the entity associated with the event. The element 914 displayed on the chat interface 712 includes text data indicating a request associated with the first additional information from the user 106.

As shown in FIG. 9B, the first additional information may be parking information. The parking information may include information of availability of parking slots in various locations inside the venue of the event. Additionally, according to the text data corresponding to the element 914, the visual response 908 of FIG. 9A is updated to a visual response corresponding to the element 916. The visual response corresponding to the element 916 will be referred to hereinafter as a visual response 916.

The visual response 916 includes an element 918, an element 920, and an element 920A. Element 918 indicates information on the selected first access rights. The element 920 indicates second access right information associated with the parking information. The second access right information includes information on second access rights.

Further, the second access rights correspond to access rights for the parking slots inside the venue of the event. The second access right information may include different options to book the second access rights, which are available. The element 920A is a user interaction element, which enables the user 106 to select multiple options for the second access rights.

Referring next to FIG. 9C, an interface diagram 800C of the hybrid interface 710 generated by the resource management system 102 for requesting second additional information according to an embodiment of the present disclosure is shown. Other than the elements shown in FIG. 9B, the hybrid interface 710 comprises an element 922, an element 924, an element 926, an element 928, and an element 930. The element 922 displayed on the chat interface 712 includes text data indicating confirmation of the selection of multiple options for the second access rights based on the user input on the visual interface 926.

The selection of options for the second access rights may book the second access rights for the hold period, similar to the booking of the first access rights. The element 924 displayed on the chat interface 712 includes text data indicating a request associated with the second additional information from the user 106.

Further, as shown in FIG. 9C, the second additional information may be insurance information. The insurance information may include information of the availability of insurance schemes for offering insurance on booking of the first access rights and/or the second access rights.

In one exemplary embodiment of the present disclosure, the insurance indicates returning of a portion of values received from the user 106 for booking of the first access rights and/or the second access rights, in case of cancellation of the first access rights and/or the second access rights. In another embodiment, the insurance indicates returning of a portion of values received from the user 106 for booking of the first access rights and/or the second access rights, in case the user 106 is unable to attend the event without cancellation of the first access rights and/or the second access rights.

The element 926 displayed on the chat interface 712 including text data generated in response to the text data corresponding to the element 924. In other words, the text data corresponding to the element 926 indicates positive user intent in response to the request associated with the second additional information. The element 928 displayed on the chat interface 712 including text data indicating a request for value information. The value information includes total values for the first access rights, the second access rights, and/or the third access rights. In addition to that, the element 926 indicates a request from the user 106 to provide a user input regarding a payment mode for payment of the values.

In another exemplary embodiment of the present disclosure, the values may include prices for the first access rights, the second access rights, and/or the third access rights. In another embodiment, the values may include credits for the first access rights, the second access rights, and/or the third access rights. In another embodiment, the value includes NFT or cryptocurrency for the first access rights, the second access rights, and/or the third access rights. In another embodiment, the value includes certain coupons for the first access rights, the second access rights, and/or the third access rights.

Additionally, according to the text data corresponding to the element 924, the visual response 926 of FIG. 9C is updated to a visual response corresponding to the element 930. The visual response corresponding to the element 930 will be referred hereinafter as a visual response 930. The visual response 930 displays third access right information associated with the insurance information on the visual interface. The third access right information includes information of third access rights. The third access rights correspond to access rights for the insurance schemes. The visual response 930 the user 106 to confirm booking of insurance schemes.

Referring next to FIG. 9D, of an interface diagram 800D of the hybrid interface 710 generated by the resource management system 102 for requesting value information and presenting confirmation for the assignment of access rights according to an embodiment of the present disclosure is shown. Other than the elements shown in FIG. 9C, the hybrid interface 710 includes an element 932, an element 934, an element 936, and an element 938. The element 932 displayed on the chat interface 712 in response to the text data corresponding to the element 928. The element 932 includes text data indicating the user input regarding the payment mode for payment of the values. The element 934 is displayed on the chat interface 712 in response to the text data corresponding to the element 932. The element 934 includes text data indicating a guidance for the user 106 to pay the values through the payment mode. The element 936 is displayed on the chat interface 712 in response to reception of the value information from the user device 104. The element 936 includes text data indicating a confirmation of the assignment of the first access rights, the second access rights, and/or the third access rights.

Additionally, according to the text response corresponding to element 936, the visual response 930 of FIG. 9C is updated to a visual response corresponding to the element 938. The visual response corresponding to the element 938 will be referred hereinafter as a visual response 938. The visual response 938 indicates the reception of the value information and the confirmation of the assignment of the first access rights, the second access rights, and/or the third access rights on the visual interface 714. In one exemplary embodiment of the present disclosure, the ticket booking application enables a user-friendly and efficient ticket booking process by providing a real-time synchronization of a chat interface and a visual interface. In another exemplary embodiment of the present disclosure, the resource management system 102 permits users to communicate user preferences in natural language through the chat interface 712, making the process easy and intuitive for users to express user booking requirements. In another exemplary embodiment of the present disclosure, the real-time visual representation of user interactions on the visual interface 714 ensures that users can see the impact of their choices immediately. This transparency aids in decision-making and increases user confidence in the booking process.

In one another exemplary embodiment of the present disclosure, the system's ability to adapt the hold period for booking access rights based on factors like request load and user affinity enhances efficiency. The users can be assured that their access rights are held for a reasonable duration.

In one another exemplary embodiment of the present disclosure, by allowing users to select payment modes based on their preferences, including prices, credits, NFTs, cryptocurrencies, or coupons, adds flexibility to the booking process, catering to a wide range of users. In one another exemplary embodiment of the present disclosure, the resource management system 102 dynamically presents additional information, such as parking and insurance details, based on user interactions, ensuring that users have access to all relevant information to make informed decisions.

In one another exemplary embodiment of the present disclosure, the confirmation provided on the visual interface 714 after receiving value information reassures users that their access rights have been successfully booked, increasing user satisfaction. In one another exemplary embodiment of the present disclosure, by providing a user-centric and highly interactive experience, while also adapting to various user preferences and event-related factors, ultimately improving efficiency and user experience.

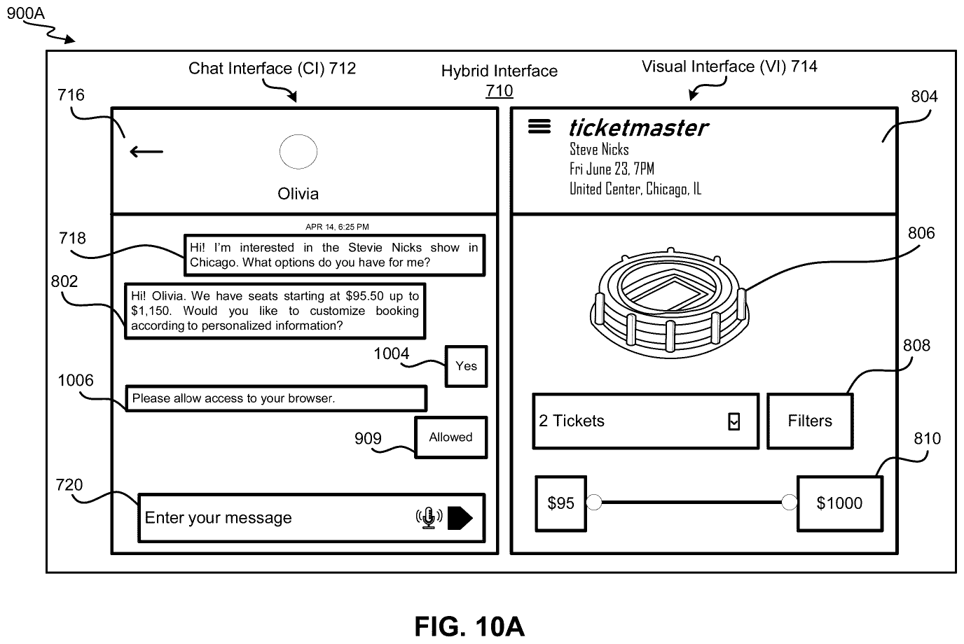

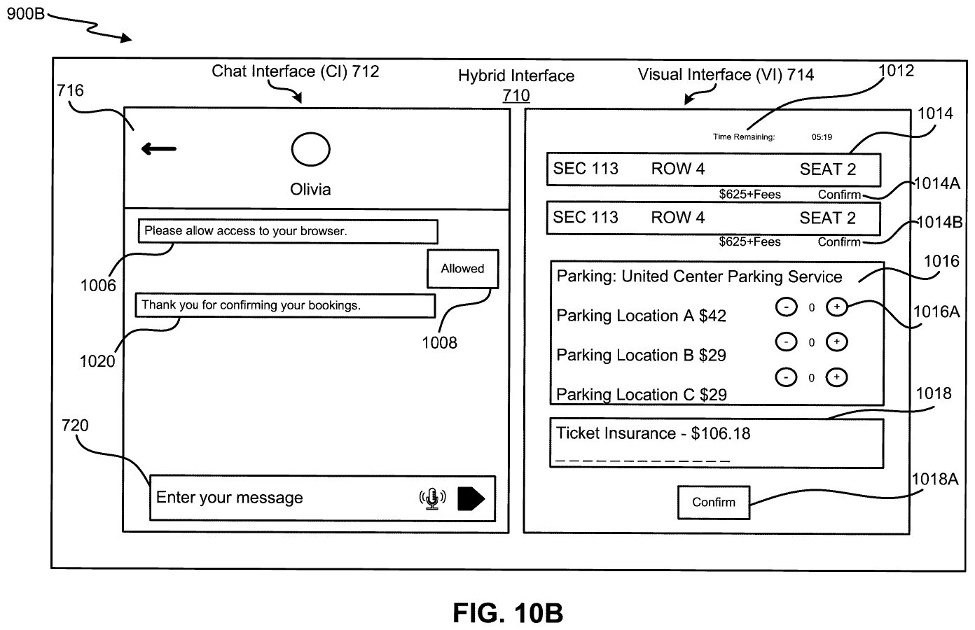

Referring next to FIG. 10A, an example embodiment of an interface diagram 900A of the hybrid interface 710 generated by the resource management system 102 for requesting a user permission to provide personalized information according to an embodiment of the present disclosure is shown. Besides the elements shown in FIG. 8, the hybrid interface 710 comprises an element 804, an element 806, an element 808, and an element 810. The element 1004 is displayed on the chat interface 712 in response to the text data corresponding to the element 718.

In other words, the element 1004 includes a text response in response to the user input indicated by the text data corresponding to the element 718. The text response corresponding to the element 1004 indicates the first access right information associated with the event. In addition to that, the text response corresponding to the element 1004 indicates a query for the user 106 to provide access right information (such as the first AR information, the second AR information, and/or the third AR information) based on the user specific data. The element 1006 displayed on the chat interface 712 in response to the text response corresponding to the element 1004.

The element 1006 includes text data indicating user input received in response to the query for providing access right information based on the user specific data. The element 1008 is displayed on the chat interface 712 in response to the text data corresponding to the element 1006. Element 1008 includes text data indicating a request to user 106 to grant permission for accessing the user specific data using a radio button 909 labelled as allowed.

Referring next to FIG. 10B, an example embodiment of an interface diagram 900B of the hybrid interface generated by the resource management system 102 for presenting personalized information and requesting confirmation for assignment of access rights according to an embodiment of the present disclosure is shown. Other than the elements shown in FIG. 10A, the hybrid interface 710 comprises an element 1012, an element 1014, an element 1014A, an element 1014B, an element 1016, an element 1016A, an element 1018, an element 1018A, and an element 1020. The element 1012 indicates a visual response displayed in response to text data corresponding to the element 1020. The visual response corresponding to the element 916 will be referred hereinafter as a visual response 1012.

Furthermore, the visual response 1012 indicates the access right information based on the user specific data. The visual response 1012 includes the element 1014, the element 1014A, the element 1014B, the element 1016, the element 1016A, the element 1018, and the element 1018A. In other words, the element 1014 provides a plurality of options of availability of first access rights based on the user specific data. The element 1014A and the element 1014B indicate user interaction elements to confirm options for booking of the first access rights. The element 1016 indicates second access right information associated with the parking information. The element 1016A is a user interaction element that enables the user 106 to select multiple options for the second access rights.

The element 1018 indicates third access right information associated with the insurance information. The element 1018A is a user interaction element which enables the user 106 to confirm booking of the insurance associated with the insurance information. The element 1020 is displayed on the chat interface 712 including text data indicating confirmation of selection of options for the first access rights, the second access rights, and/or the third access rights based on the user input received on the visual interface 1012.

The resource management system 102 repeats the same process for assigning the access rights (first access rights, the second access rights, and/or the third access rights) to the user 106 after receiving the confirmation of the selection of the access rights in this embodiment same as embodiments explained in FIG. 9A, FIG. 9B, FIG. 9C, and FIG. 9D.

In one exemplary embodiment of the present disclosure, the machine learning model 110 utilizes historical user interactions and preferences to present access right information tailored to the user's preferences, leading to more successful event bookings. In another exemplary embodiment of the present disclosure, users can confirm access rights options in real-time through various input methods, such as clicks, touches, audio, or text inputs, thus making the booking process seamless.

In another exemplary embodiment of the present disclosure, the machine learning model 110 analyzes user-specific data to recommend access rights options that align with the user's past preferences or current context and thus increase the likelihood of successful bookings. In one exemplary embodiment of the present disclosure, the hybrid interface 710 integrates chat-based interactions and visual content, improving user engagement and facilitating the booking process. In one exemplary embodiment of the present disclosure, the AI model detects user intent based on natural language input, allowing for an intuitive and user-driven booking process that results in accuracy in understanding user preferences and needs.

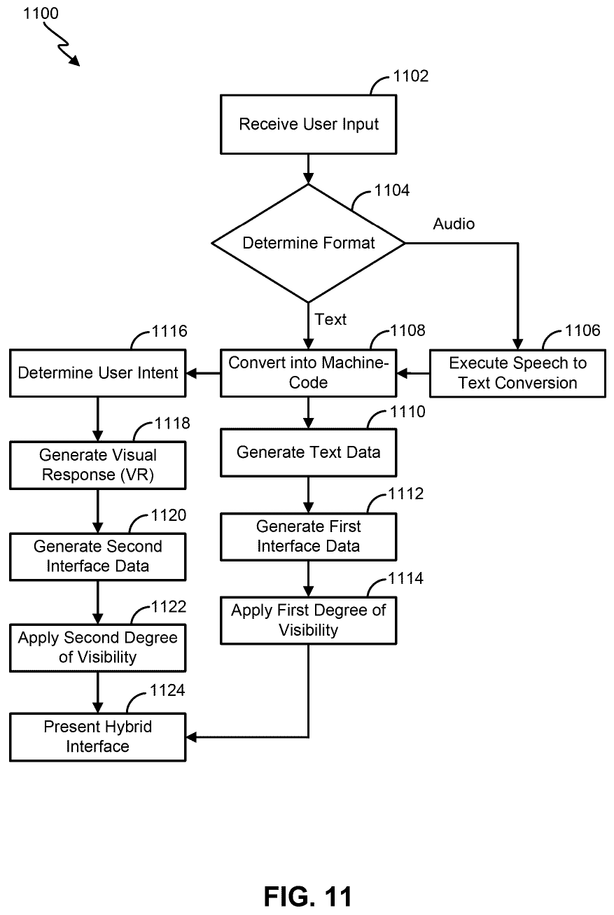

Referring next to FIG. 11, a flowchart 1100 for generating the hybrid interface 710 is shown according to an embodiment of the present disclosure. Flowchart 1100 explains an exemplary method to be executed by the resource management system 102 for generating the hybrid interface 710. At block 1102, the user input is received to initiate the presentation of the hybrid interface 710. The user input may be in a natural language. User 106 may provide user input on the user device 104 with respect to the system application associated with the resource management system 102.

The resource management system 102 receives the user input from the user device 104. In an embodiment, the system application may initially present a user interface to receive the user input from the user 106.

At block 1104, the format of the user input is determined. The resource management system 102 determines whether the user input is received by creating a pressure signal on the user interface or by a microphone of the user device 104.

In other words, the resource management system 102 determines the format of the user input as text or audio. In case the format of the user input is audio, the method proceeds to block 1106. On the other hand, if the format of the user input is text, the method proceeds to block 1108.

At the block 1106, the speech to text conversion is executed on the audio input. The resource management system 102 executes machine learning algorithms to convert the audio input into the text input. At the block 1108, the natural language of the user input received at the block 1102 is converted into a machine level language to be processed by the system processors 406 of the resource management system 102. The compiler 412 of the resource management system 102 converts the natural language into the machine level language. Then, the method proceeds to block 1110 and block 1116.

At the block 1110, the text data is generated based on the machine level language generated at the block 1108. The text data indicates the user input received at the block 1102. The resource management system 102 generates the text data to be presented on the hybrid interface 710. The element 718 of FIG. 7B may indicate the generated text data.

At block 1112, the first interface data is generated based on the text data generated at block 1110. The first interface data may correspond to the chat interface (CI) 712 as shown in FIGS. 7B-10B. The resource management system 102 generates the first interface data to be transmitted to the user device 104 in response to the user input received at the block 1102.

At the block 1114, the first degree of visibility is applied to the first interface data generated at the block 1112. The resource management system 102 adjusts the first interface data to be visible on the user device 104 with the first degree of visibility. Adjusting the first interface data to the first degree of visibility may indicate the presentation of the chat interface 712 as a translucent interface. Then, the method proceeds to block 1124.

At the block 1116, a user intent is determined from the user input received at the block 1102 based on the machine level language generated at the block 1108. The resource management system 102 parses the user input and may execute machine learning algorithms to determine the user intent. Then, the method proceeds to block 1118.

At the block 1118, a visual response (VR) is generated based on the user intent determined at the block 1116. The resource management system 102 generates the visual response as shown by the visual interface 714 in FIG. 7B.

At the block 1120, second interface data is generated based on the visual response generated at the block 1118. The second interface data may correspond to the visual interface (VI) 714 as shown in FIGS. 7B-10B. The resource management system 102 generates the second interface data to be transmitted to the user device 104 in response to the user input received at the block 1102.

At the block 1122, the second degree of visibility is applied to the second interface data generated at the block 1120. The resource management system 102 adjusts the second interface data to be visible on the user device 104 with the second degree of visibility. Adjusting the second interface data to the second degree of visibility may indicate the presentation of the visual interface 714 as a transparent interface. The translucent interface may be blurred with respect to the transparent interface as explained in the block 1114.

Finally, at block 1124, the hybrid interface 710 is presented on the user device 104 based on the first interface data generated at the block 1112 and the second interface data generated at the block 1120. The resource management system 102 transmits hybrid interface data associated with the first interface data and the second interface data to the user device 104. The user device 104 is enabled to present the hybrid interface 710 based on the hybrid interface data.

The elements of the hybrid interface 710 according to FIGS. 10A and 10B may be similar to the elements of the hybrid interface 710 as shown in FIG. 7B. The hybrid interface 710 is divided into the chat interface 712 and the visual interface 714 as shown in FIGS. 7B-10B, where the content of the chat interface 712 (such as the element 718) is presented based on the first interface data, and the visual interface 714 (such as the element 718) is presented based on the second interface data. The first interface data is displayed as the translucent interface with the first degree of visibility, and the second interface data is displayed as the transparent interface with the second degree of visibility.

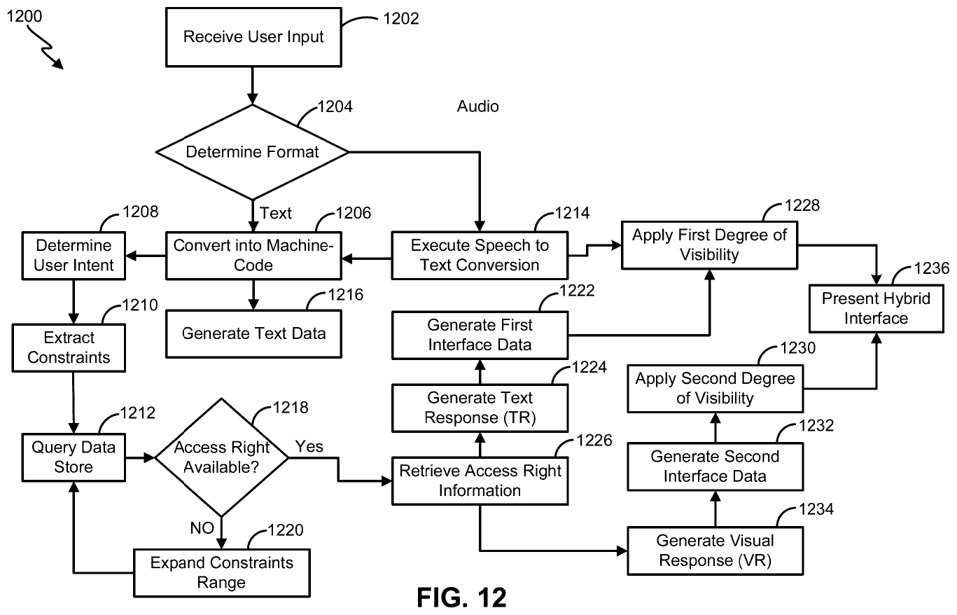

Referring next to FIG. 12, a flowchart 1200 for generating the hybrid interface 710 according to an embodiment of the present disclosure is shown. Flowchart 1200 explains another exemplary method to be executed by the resource management system 102 for generating the hybrid interface 710. Blocks 1202, 1204, 1206, 1208, 1210, and 1214 will be executed like blocks 1102, 1104, 1106, 1108, 1110, and 1116 of FIG. 11, respectively.

At block 1210, constraints based on the user intent determined at the block 1208 are determined. As shown in FIG. 7B, the user intent from the text data corresponding to the element 718 indicates intention of the user 106 to check the first access rights for an event associated with the performer “Stevie Nicks” scheduled in a location “Chicago”. The resource management system 102 analyzes the user intent to determine constraints like event, location, value range, date, time, performer, etc. At block 1212, the resource data store 112 is queried based on the constraints. The resource management system 102 queries the resource data store 112 to determine the availability of the first access rights associated with the event. At the block 1218, the availability of the first access rights is determined. The resource management system 102 may examine status of each of the first access rights stored in the resource data store 112 to determine the availability of the first access rights. In case the first access rights are available, the method proceeds to block 1224. On the other hand, if the first access rights are not available, the method proceeds to block 1222.

At the block 1220, range of constraints will be expanded such that the first access rights become available. The resource management system 102 may expand the range of some constraints like location, time, date or price range to query the resource data store 112 such that returning of empty response to the user device 104 may be avoided. Then, the method proceeds to block 1218.

At the block 1226, the first access right information is retrieved from the resource data store 112 based on the availability of the first access rights. The resource management system 102 retrieves the first access right information in response to the user input received at the block 1202. Then, the method proceeds to block 1224 and block 1234.

At the block 1224, the text response is generated based on the first access right information retrieved at the block 1226. The resource management system 102 generates the text response in response to the user input received at the block 1202. The text response includes information about availability of the first access rights and a query for providing the user preference for the booking of the first access rights. The element 802 of FIG. 8 may indicate the generated text response. Then, the method proceeds to block 1212.

At the block 1222, the first interface data is generated based on the text data generated at the block 1216 and the text response generated at the block 1224. The first interface data may correspond to the chat interface (CI) 712 as shown in FIGS. 7B-10B. The resource management system 102 generates the first interface data to be transmitted to the user device 104 in response to the user input received at block 1202. Then, the method proceeds to block 1228.

At the block 1228, the first degree of visibility is applied to the first interface data generated at the block 1222. The explanation for the application of the first degree of visibility to the first interface data is given above with respect to the block 1214 of FIG. 12. Then, the method proceeds to block 1236.

At the block 1234, a visual response is generated based on the first access right information retrieved at the block 1226. The resource management system 102 generates the visual response as shown by the element 804 in FIG. 8. Then, the method proceeds to block 1232.

At the block 1232, the second interface data is generated based on the visual response generated at the block 1234. The explanation for the generation of the second interface data is given above with respect to the block 1120 of FIG. 11. Then, the method proceeds to block 1230.

At the block 1230, the second degree of visibility is applied to the second interface data generated at the block 1232. The explanation for the application of the second degree of visibility to the second interface data is given above with respect to the block 1122 of FIG. 11. Then, the method proceeds to block 1236.

At block 1236, the hybrid interface 710 is presented on the user device 104 based on the first interface data generated at block 1222 and the second interface data generated at block 1232. The explanation for generating the hybrid interface 710 is given above to block 1124 of FIG. 11. The elements of the hybrid interface 710, according to FIG. 12, may be similar to the elements of the hybrid interface 710 as shown in FIG. 8.

In one exemplary embodiment of the present disclosure, the multi-model e-commerce system is applied to event ticket booking, where users can interact with a chatbot, specify their preferences, and receive text and visual information about ticket availability, including seat maps and interactive selection options. In another exemplary embodiment of the present disclosure, the machine learning model 110 is utilized for booking concert tickets, where users can see a visual representation of the concert venue and select specific seats based on their preferences and budget, all while conversing with a natural language chatbot.

In one exemplary embodiment of the present disclosure, the system and method provide an improved user experience by combining natural language interaction with a visual interface for ticket booking. Users can seamlessly communicate their preferences, receive relevant information, and make informed decisions, enhancing the efficiency and satisfaction of the e-commerce process.

In one exemplary embodiment of the present disclosure, this concept can be applied to various e-commerce domains beyond event ticket booking, such as travel booking, product purchasing, and more. It simplifies the user's decision-making process and provides a user-friendly interface that caters to both text-based and visual learners.

In one exemplary embodiment of the present disclosure, the machine learning model 110 provides a chat interface on the first interface where the user can interact naturally with a chatbot. The AI algorithms analyze the user's intent and generate a text response with information about ticket availability and user preferences. Simultaneously, a visual response is generated based on ticket availability. This permits users to have a more interactive and informative booking experience, enhancing their overall user experience.

In one exemplary embodiment of the present disclosure, the system efficiently handles constraints by expanding one or more constraints if ticket availability is insufficient. This ensures that users receive relevant ticket options even when initial constraints are too restrictive. This approach improves the chances of fulfilling user requests and reduces the likelihood of empty responses.

In one exemplary embodiment of the present disclosure, the machine learning model 110 presents a hybrid interface to the user, combining the informative text response with a visual representation of ticket availability. This hybrid interface provides users with both textual and visual information, catering to different user preferences and making the ticket booking process user-friendly and accessible.

In one exemplary embodiment of the present disclosure, the system facilitates personalized user engagement by adapting the chat interface and visual representations in real-time based on the user's evolving interactions and multifaceted intent. This dynamic adaptation enhances the user's engagement and encourages them to explore a broader range of ticket options, ultimately leading to more satisfying ticket booking experiences.

In one exemplary embodiment of the present disclosure, the machine learning model 110 maintains contextual awareness by modulating the visibility of interface elements based on the ongoing user interaction context. This ensures that users are presented with relevant information and interactive options, promoting a more efficient and enjoyable ticket booking process.

In one exemplary embodiment of the present disclosure, the system provides comprehensive event discovery by presenting users with both textual and visual insights, allowing them to explore event details, ticket availability, and pricing information simultaneously. This multifaceted approach empowers users to make well-informed ticket booking decisions, thereby enhancing their overall experience.

In one exemplary embodiment of the present disclosure, the system's chatbot interface component initiates natural language interactions with users, employing advanced natural language processing algorithms to detect user intent. Upon determining the user's intent, the system utilizes machine learning algorithms to parse and evaluate multifaceted user requirements, including event specifics, constraints, and preferences.

In one exemplary embodiment of the present disclosure, suppose a user is interested in concert tickets within a specific budget. The system applies the first degree of visibility, adjusting the visibility of ticket options based on the user's budget constraints. Tickets falling within the budget are prominently displayed, while those exceeding the budget are partially obfuscated, ensuring the user's focus on affordable options.

Further, a first interface is dynamically generated based on text responses enriched with real-time ticket availability insights. For instance, if a user enquires about available seats for a music concert, the first interface may present details such as seat availability, pricing, and event timings in a text-based chat format, facilitating a dynamic and interactive conversation with the user.

In one exemplary embodiment of the present disclosure, the system interfaces with the resource data repository to execute data queries aligned with user constraints. Real-time visual representations of ticket availability, incorporating dynamic elements and data visualization techniques, are synthesized using visual content generation mechanisms.

In addition, visual content synthesizers craft second interface data, translating real-time visual responses into user-friendly visual elements. For example, for event tickets, a second interface may display an interactive seating chart, allowing users to view available seats and their respective prices, and enhancing the user's visualization and understanding.

In one exemplary embodiment of the present disclosure, the system employs a second degree of visibility applicator to dynamically adjust the visibility of components within the second interface data. For instance, if a user wishes to explore VIP ticket options, the second degree of visibility ensures that VIP seating details are prominently displayed, allowing users to assess premium options clearly.

Moreover, the hybrid interface controller merges the first and second interface data, presenting users with a unified interface that seamlessly integrates textual and visual elements. For example, a user interested in concert tickets experiences a cohesive interface displaying both text-based details (such as event information and ticket availability) and visually intuitive elements (such as interactive seating charts), creating a multifaceted and engaging user experience.

In one exemplary embodiment of the present disclosure, the computer-implemented system and method for ticket booking solving existing technical problems and enhancing user interactions by seamlessly combining natural language processing, real-time data analysis, and dynamic visual content presentation. The resulting hybrid interface provides users with a comprehensive, interactive, and personalized booking experience.

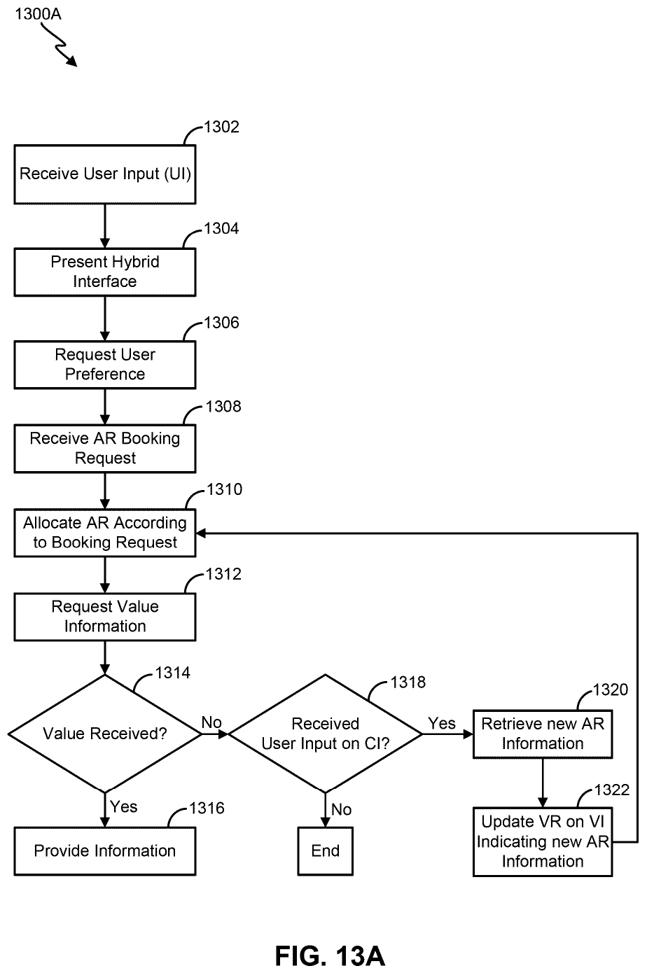

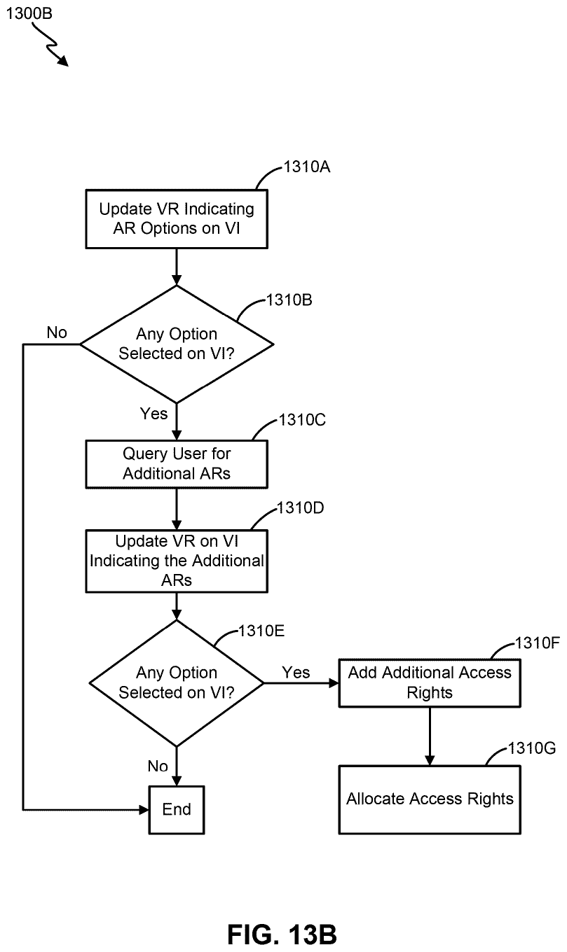

Referring next to FIG. 13A, a flowchart 1300A for generating the hybrid interface 710 for booking the access rights to the event according to an embodiment of the present disclosure is shown. The flowchart 1300A explains an exemplary method to be executed by the resource management system 102 for booking of the access rights to the event. At block 1302, the user input is received to initiate presentation of the hybrid interface 710. The details of reception of the user input are explained above with respect to block 1102 of FIG. 11.

At the block 1304, the hybrid interface 710 is presented based on the user input. The details of presentation of the hybrid interface 710 based on the user input are explained above with respect to FIG. 12. The elements of the hybrid interface 710 according to FIG. 13A may be similar to certain elements of the hybrid interface 710 as shown in FIG. 9A.

At the block 1306, a user preference for booking of the access rights is requested from the user device 104. The resource management system 102 may determine user intent from the user input received at the block 1302. Further, the resource management system 102 transmits a request for the user preference to the user device 104 in response to the determined user intent. The request of the user preference may be indicated by the element 802 as shown in FIG. 9A.

At the block 1308, access right (AR) booking request is received from the user device 104. The resource management system 102 may receive the access right booking request in response to the request of the user preference. The reception of the access right booking request may be indicated by the element 904 as shown in FIG. 9A.

At the block 1310, the access rights are allocated according to the access right booking request. The details of the allocation of the access rights will be explained in FIG. 13B. Then, the method proceeds to block 1312.

At the block 1312, the value information is requested from the user device 104. The resource management system 102 may request the value information from the user device 104 for assignment of the allocated access rights to the user 106. The request for the value information is explained in detail with respect to FIG. 9C.

At block 1314, a determination is made that whether the value information is received from the user device 104. The user 106 may provide the value information by the use of a third-party server. The resource management system 102 may determine the reception of the value information based on a confirmation signal received from the third-party server. In case the value information is received, the method proceeds to block 1316. On the other hand, if the value information is not received, the method proceeds to block 1318.

At the block 1316, confirmation of assignment of the access rights is provided to the user device 104. In one embodiment, the resource management system 102 may update the visual response on the visual interface 714 to indicate the confirmation of the assignment of the access rights to the user device 104. The element 938 as shown in FIG. 9D may indicate the confirmation of the assignment of the access rights on the visual interface 714.

In one exemplary embodiment of the present disclosure, the resource management system 102 may provide the confirmation by generating text data on the chat interface 712. The element 936 as shown in FIG. 9D may indicate the confirmation of the assignment of the access rights on the chat interface 712.

At the block 1318, whether the user input is received on the chat interface 712 to request new access rights for another event is determined. The resource management system 102 determines whether the user input is received for the new access rights in response to the determination that the value information for booking of the access rights is not received. In case the user input for the new access rights is received, the method proceeds to block 1320. On the other hand, if the user input for the new access rights is not received, a process of the method will be ended.

At the block 1320, new access right information associated with the new access rights is retrieved from the resource data store 112. The resource management system 102 retrieves the new access right information according to the user input received at the block 1318.

At the block 1322, the visual response is updated on the visual interface 714 indicating the new access right information of the new event. The resource management system 102 updates the visual interface 714 based on the new access right information is retrieved from the resource data store 112. Then, the method proceeds back to the block 1310.

Referring next to FIG. 13B, a flowchart 1300B for allocating the access rights to the user device 104 based on an access right booking request according to an embodiment of the present disclosure is shown. The flowchart 1300B explains an exemplary method to be executed by the resource management system 102 for allocating the access rights to the user device 104 based on an access right booking request. At block 1310A, the visual response is updated on the visual interface 714 to indicate the access right information.

Further, the resource management system 102 may retrieve the access right information from the resource data store 112 in response to the access right booking request received at the block 1308 of FIG. 13A. Further, the resource management system 102 updates the visual interface 714 to indicate the access right information based on the access right information retrieved from the resource data store 112. The access right information may include options for selection of the first access rights as explained with respect to FIG. 9A. The element 908 as shown in FIG. 9A may indicate the access right information presented on the visual interface 714.

At block 1310B, a determination is made that whether at least one option of the plurality of options is selected on the visual interface 714 for booking of the first access rights. The resource management system 102 determines the selection of the at least one option based on the user input received for the at least one option on the visual interface 714. In case the at least one option for booking of the first access rights is selected, the method proceeds to block 1310C. On the other hand, if the at least one option for booking of the first access rights is not selected, a process of the method will be ended.

At the block 1310C, a query for allocating additional access rights is transmitted to the user device 104. The resource management system 102 transmits the query for the allocation of the additional access rights based on the first access rights booked by the user 106. The additional access rights may include at least one of the second access rights or the third access rights as explained with respect to FIGS. 9B and 9C. Then, the method proceeds to the block 1310D.

At the block 1310D, the visual response on the visual interface 714 is updated to indicate the additional access right information. The resource management system 102 receives user confirmation in response to the query transmitted at the block 1310C. Based on the user confirmation, the resource management system 102 retrieves the additional access right information from the resource data store 116.

Further, the resource management system 102 indicates the additional access right information based on the additional access right information retrieved from the resource data store 116. The additional access right information may include options for selection of the second access rights and/or the third access rights. The elements 916 and 930 may indicate the additional access right information presented on the visual interface 714.

At the block 1310E, a determination is made that whether at least one option of the plurality of options is selected on the visual interface 714 for booking of the additional access rights. The resource management system 102 determines that the selection of the at least one option based on the user input is received for the at least one option on the visual interface 714. In case the at least one option for booking of the additional access rights is selected, the method proceeds to block 1310F. On the other hand, if the at least one option for booking of the additional access rights is not selected, the process of the method will be ended.

At the block 1310F, the additional access rights are added to the user device 104 in response to the selection of the at least one option. The resource management system 102 adds the additional access rights to the first access rights which were booked by the user at block 1310B for allocation of the access rights to the user device 104. At the block 1310G, the first access rights and the additional access rights are allocated to the user device 104 based on addition of the additional access rights to the first access rights.

In one exemplary embodiment of the present disclosure, the ability of the resource management system 102 to receive the user input in a natural language on the chat interface 712 and accordingly provide the text response on the chat interface 712 along with the visual response on the visual interface 714, encourage various users to conveniently book the access rights. The user may interact with the resource management system 102 effortlessly, and hence obviating the requirement of having expertise in the relevant field. Further, applying different degrees of visibility to the chat interface 712 and the visual interface 714 the user accomplishes clear and quick direction for the user to provide user input on required sections of the hybrid interface 710.

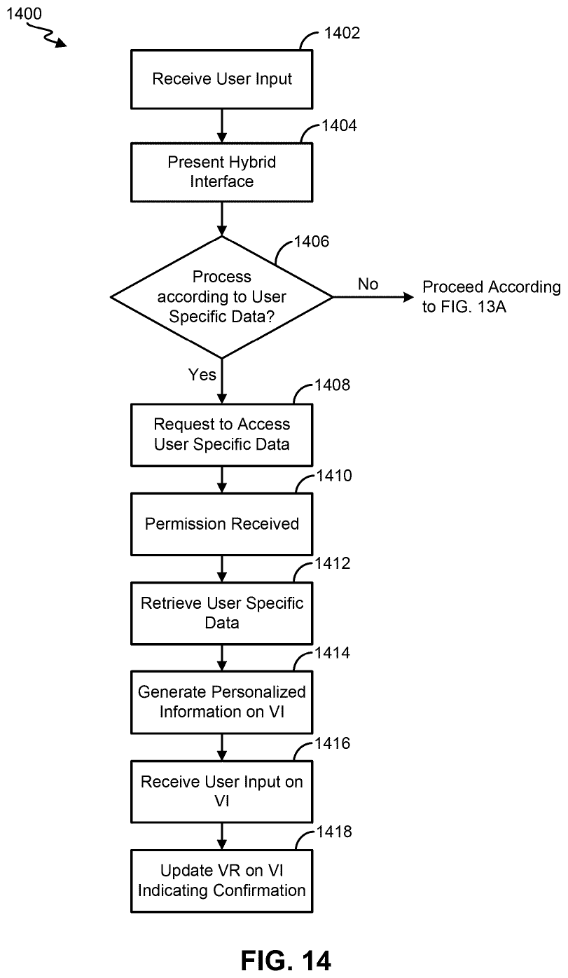

Referring next to FIG. 14, a flowchart 1400 for generating hybrid interfaces for booking the access rights to the event according to an embodiment of the present disclosure is shown. The flowchart 1400 explains an exemplary method to be executed by the resource management system 102 for booking of the access rights based on the user specific data. At block 1402, the user input is received to initiate presentation of the hybrid interface 710. The details of reception of the user input are explained above with respect to block 1102 of FIG. 11.

At the block 1404, the hybrid interface 710 is presented based on the user input. The details of presentation of the hybrid interface 710 based on the user input are explained above with respect to FIG. 12. The elements of the hybrid interface 710 according to FIG. 14 may be similar to certain elements of the hybrid interface 710 as shown in FIG. 10A.

At the block 1406, a determination is made that whether the process of booking the access rights to the event is to proceed according to the user specific data. The hybrid interface 710 presented in the block 1404, includes an element (such as element 1004), which indicates a query for the user 106 that whether access right information is provided based on the user specific data. The resource management system 102 determines whether the user input is received for the element of the hybrid interface 710.

Further, in response to reception of the user input, the user intent according to the user input is determined, as explained in the block 1116 of FIG. 11. In case the user intent is determined to be positive, then, the resource management system 102 determines that the process of booking the access rights to the event will be proceed according to the user specific data.

Furthermore, if the resource management system 102 determines that the process of booking the access rights to the event will proceed according to the user specific data, the method proceeds to block 1408. On the contrary, if the user intent is determined to be negative, then, the resource management system 102 determines that the process of booking the access rights to the event will not proceed according to the user specific data. Then, the process of booking of the access rights will proceed according to blocks 1306 to 1320 of FIG. 13A.

At the block 1408, accessing the user specific data is requested from the user 106. The resource management system 102 transmits a request to access the user specific data in response to the determination that the process of booking the access rights to the event is to proceed according to the user specific data. The resource management system 102 generates a text response to be presented as an element (such as element 1008) on the hybrid interface 710. The element indicates the request to access the user specific data.

At the block 1410, permission to access the user specific data is received from the user device 104. The resource management system 102 determines that the user input is received in response to the request transmitted at the block 1408. Further, the resource management system 102 determined the user intent from the user input as explained in the block 1116 of FIG. 11. The resource management system 102 determines that permission to access the user specific data is received from the user device 104 based on the user intent is determined to be positive.

At the block 1412, the user specific data is retrieved. The resource management system 102 transmits a request to retrieve the user specific data to the user device 104 or the user database 108. In case the user specific data is the historical interactions of the user 106 with the resource management system 102, the resource management system 102 may transmit the request to the user database 108.

At the block 1414, personalized information is presented on the visual interface 714. The personalized information presented on the visual interface 714 may be similar to the element 1012 as shown in FIG. 10B. The resource management system 102 uses the user specific data to determine the access right information (the first access right information, the second access right information, and the third access right information) which is likely to be accepted by the user 106.

In one exemplary embodiment of the present disclosure, the resource management system 102 identifies from the historical interactions that the user 106 usually books some specific access rights for the events associated with an entity. Accordingly, the resource management system 102 presents the access right information of the access rights similar to the specific access rights that have been booked by the user 106 in a frequent manner.

In another embodiment, the resource management system 102 identifies from the web searches in the user device 104 that the user 106 has searched some specific access rights for the events associated with the entity. Accordingly, the resource management system 102 presents the access right information of the access rights similar to the specific access rights that have been searched by the user 106.

In one exemplary embodiment of the present disclosure, the resource management system 102 identifies certain events associated with the entity closer to the current location of the user 106. Accordingly, the resource management system 102 presents the access right information of the access rights of the events which are closer to the location of the user 106. Further, the personalized information includes options to confirm the access rights for the event.

At the block 1416, the user input is received to confirm at least one option is included in the personalized information presented on the visual interface 714. The resource management system 102 identifies the user input on the at least one option and proceeds for booking of the access rights corresponding to the user input.

In one exemplary embodiment of the present disclosure, the user 106 can submit a click or touch operation on the at least one option displayed on the visual interface 714. In another embodiment, the user can provide audio input or text input on the chat interface 712 via the element 720 of the hybrid interface 710 to confirm the at least one option.

Finally, at block 1418, the visual response including the personalized information on the visual interface 714 is updated to indicate confirmation of the assignment of the access rights. After identifying the user input on the at least one option, the resource management system 102 may execute functions similar to blocks 1312 to 1316 of FIG. 13A for receiving the value information, assigning the access rights to the user 106, and indicating the confirmation of the assignment of the access rights.

In one exemplary embodiment of the present disclosure, the system further enhances user interaction by integrating a second visual interface, personalized to each user's preferences and historical interactions. Further, this second interface operates in conjunction with the AI-enabled chatbot interface, creating a seamless and intuitive ticket booking experience for the user.

In one exemplary embodiment of the present disclosure, the system detects user intent from the natural language input received on the chatbot interface. For instance, if a user enquires about VIP ticket options for an upcoming concert, the AI model discerns the intent for premium access.

In addition, in response to the detected user intent, the system triggers the presentation of access right information on the second visual interface. This interface dynamically displays personalized options, incorporating historical user interactions and preferences. For example, if the user has previously preferred aisle seats, the second interface customizes the displayed ticket options to prioritize such seating arrangements.

In one exemplary embodiment of the present disclosure, the second visual interface empowers users with real-time interaction capabilities, allowing them to confirm their access rights options seamlessly. Moreover, users can engage with the interface through various means such as clicks, touches, audio inputs, or text inputs. This interactive approach ensures that users have control over their choices, fostering a sense of agency in the ticket booking process.

In one exemplary embodiment of the present disclosure, the second visual interface incorporates dynamic visual content, such as interactive seating charts and event venue layouts. For instance, users exploring concert tickets can view an interactive seating map where available seats are color-coded based on pricing tiers, facilitating informed decisions.

Furthermore, using the detected user intent and historical interactions, the system tailors the access rights options presented on the second visual interface. For example, a user expresses interest in a specific artist's concert, the interface showcases ticket packages related to that artist's performances, ensuring a personalized and relevant ticket booking experience.

In one exemplary embodiment of the present disclosure, upon confirmation of access rights choices, the second visual interface updates in real-time to reflect the user's selections. This seamless update ensures that users are always presented with the most current and accurate information. The hybrid interface controller integrates the dynamically updated second visual interface with the existing chatbot interface and first visual interface, creating a cohesive and unified hybrid interface.

Furthermore, the hybrid interface seamlessly merges textual information from the chatbot interface, real-time updates from the second visual interface, and interactive elements from the first visual interface. For instance, after confirming ticket options on the second interface, users can review their choices in the chatbot interface and even receive a confirmation message with booking details, creating a unified and consistent user experience.

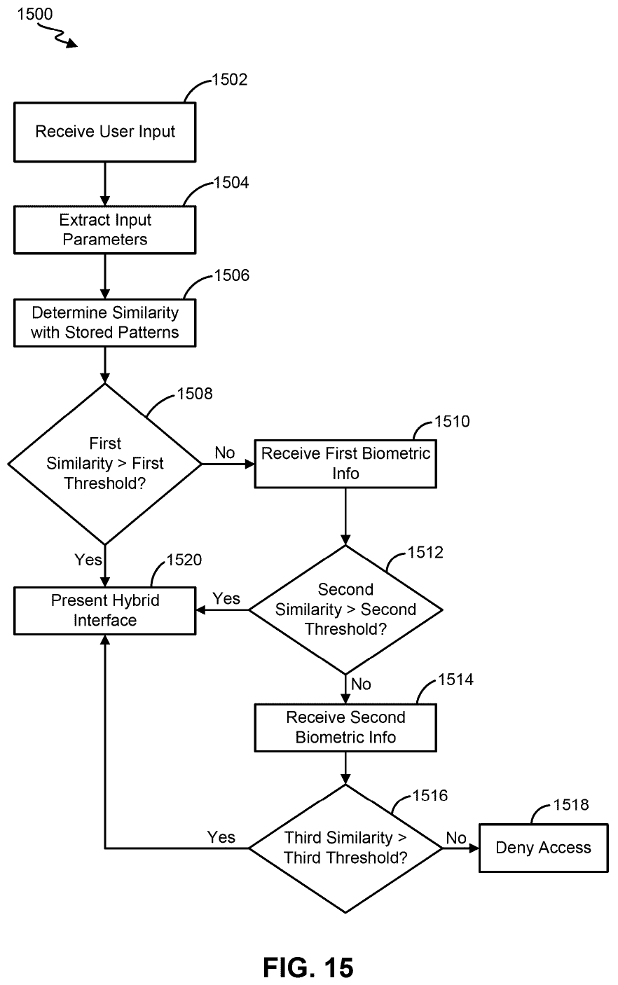

Referring next to FIG. 15, a flowchart 1500 for authenticating the user 106 to access the system application associated with the resource management system 102 according to an embodiment of the present disclosure is shown. At block 1502 the user input is received from the user device 104. The resource management system 102 determines the reception of the user input on the system application installed on the user device 104.

In one exemplary embodiment of the present disclosure, the user input may be received to initiate presentation of the hybrid interface 710, such as on the element 708 as shown in FIG. 7A. In another embodiment, the user input may be received on the element 720 as shown on FIGS. 7B-10B. The use input may be in text format or audio format.

At the block 1504, input parameters are extracted from the user input. The resource management system 102 analyzes the user input to extract the input parameters. The input parameters may include structure of the user input, constraints for the access rights included in the text input, location of a user device from which the text input is received, and the like. The constraints may include location of the event, number of access rights requested for the event, value range of the access rights, access right location (like front row, middle row, first column etc.) of the access rights, and the like.

At the block 1506, a first similarity between the input parameters and a plurality of patterns is determined. The resource management system 102 may store the plurality of patterns of the user input in a database to distinguish between the human users and the bot users. In an embodiment, the stored plurality of parameters may include a first set of patterns of the user input sent by the human users and a second set of patterns sent by the bot users. In other words, for the same user intent, patterns of the user input sent by the human users may differ from the patterns of the user input sent by the bot users.

Moreover, the plurality of patterns of the user input may include a defined structure of the user input, a defined distance between a location of a user device from which a user input is received and a location of an event for which access rights is requested in the user input, a defined number of the access rights.

Further, the resource management system 102 compares the input parameters extracted from the user input with the patterns to determine the first similarity between the input parameters with the first set of patterns. For example, a structure of the user input received from the user device 104 is compared with the defined structure included in the patterns to determine a first parameter of the first similarity. In another example, the distance between a location of the user device 104 and a location of the event for which the access rights is requested in the user input received from the user device 104 is compared with the defined distance included in the patterns to determine a second parameter of the first similarity.

In one exemplary embodiment of the present disclosure, the number of access rights requested in the user input received from the user device 104 is compared with the defined number of access rights included in the patterns to determine a third parameter of the first similarity. Further, the resource management system 102 may calculate a weighted combination of different parameters to determine the first similarity. The first similarity may be expressed in one of a rating, a value, a percentage, a degree, and the like.

At the block 1508, the determined first similarity is compared to a first threshold. The resource management system 102 compares the determined first similarity with the first threshold to determine if the user 106 is the human user or the bot user. In case the first similarity is greater than or equal to the first threshold, the method proceeds to block 1520. At block 1520, the hybrid interface 710 is presented at the user device 104. On the other hand, if the first similarity is lesser than the first threshold, the method proceeds to block 1510.

At the block 1510, first biometric information is received by the user device 104. The resource management system 102 may transmit a request to the user device 104 for the first biometric information based on the determination that the first similarity is lesser than the first threshold. Furthermore, the resource management system 102 receives the first biometric information in response to the transmitted request. The first biometric information may include at least one of a fingerprint scan or a retina scan of the user 106. Then, the method proceeds to block 1512.

At the block 1512, a second similarity is compared with a second threshold. The resource management system 102 compares the received first biometric information with stored biometric information of the user 106. During registration of the user 106 in the system application, the resource management system 102 may prompt the user 106 to provide certain biometric information such as real-time fingerprint scan or real-time retina scan of the user 106 from the user device 104 and stored in a database.

Further, the resource management system 102 system determines the second similarity as a result of the comparison. The second similarity may be expressed in one of a rating, a value, a percentage, a degree, and the like. In case the second similarity is greater than or equal to the second threshold, the method proceeds to block 1520. On the other hand, if the second similarity is lesser than the second threshold, the method proceeds to block 1514.

At the block 1514, second biometric information is received by the user device 104. The resource management system 102 may transmit a request to the user device 104 for the second biometric information based on the determination that the second similarity is lesser than the second threshold.

Furthermore, the resource management system 102 receives the second biometric information in response to the transmitted request. The second biometric information may include an image of the user 106 captured by the user device 104. The resource management system 102 may control the user device 104 to capture a real-time image of the user 106 in response to the determination that the second similarity is lesser than the second threshold.

At the block 1516, a third similarity is compared with a third threshold. The resource management system 102 compares the received second biometric information with the stored biometric information of the user 106. During registration of the user 106 in the system application, the resource management system 102 may control the user device 104 to capture a real time image of the user 106 and stored in the database.

Further, the resource management system 102 system determines the third similarity as a result of the comparison. The third similarity may be expressed in one of a rating, a value, a percentage, a degree, and the like. In case the third similarity is greater than or equal to the third threshold, the method proceeds to block 1520. On the other hand, if the third similarity is lesser than the third threshold, the method proceeds to block 1518.

At the block 1518, the user 106 is identified as the bot user and access to the access right information requested in the user input received at the block 1502 is denied. At the block 1520, the user 106 is identified as the human user and the hybrid interface 710 is presented on the user device 104 in response to the user input received at the block 1502. The resource management system 102 uses the biometric information to prevent access to the system application by unauthorized users.

In one exemplary embodiment of the present disclosure, the machine learning model 110 uses a combination of input parameters and biometric information to authenticate users. The technical effect is improved security by distinguishing between human users and bots, and ensuring that access rights are only granted to legitimate users. This enhances the overall system's reliability in preventing unauthorized access.

In one exemplary embodiment of the present disclosure, this embodiment can be particularly useful for ticket booking systems where fraud prevention and user authentication are critical. By incorporating biometric data, the machine learning model 110 provides an additional layer of security, reducing the risk of ticket scalping and fraud.

In one exemplary embodiment of the present disclosure, the machine learning model 110 calculates a weighted combination of parameters to determine similarity. This allows for a flexible and adaptive authentication process that considers multiple factors for user identification.

In one exemplary embodiment of the present disclosure, the machine learning model 110 can adapt to changing patterns of user behavior and input, making the system resilient to evolving bot tactics. It ensures that even if a bot tries to mimic human input patterns, it will still be detected based on the combination of factors.

In one exemplary embodiment of the present disclosure, the system uses both biometric information and pattern matching to determine user authenticity. Thus, a robust two-factor authentication process enhances security. In one exemplary embodiment of the present disclosure, in high-security scenarios, such as access to sensitive events or data, users are required to provide both biometric data and valid input patterns, making it hard for unauthorized users to gain access.

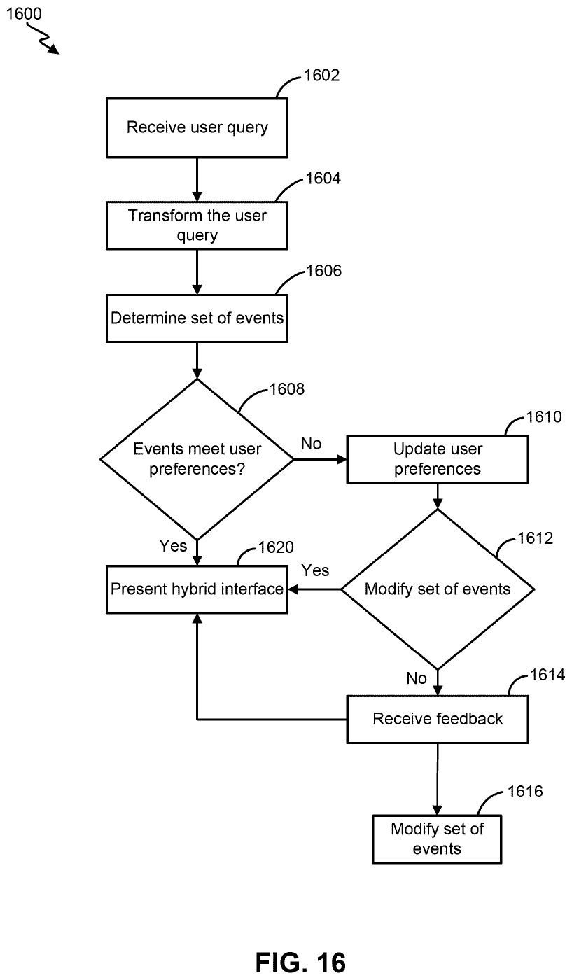

Referring next to FIG. 16, a flowchart 1600 for determining the recommendations for the user based on user preferences and user patterns according to an embodiment of the present disclosure is shown. At the block 1602 the user input is received from the user of the user device 104. The user provides the input via the user interface on the user device 106. The user input can be a user query for events from the system application of the multi-modal e-commerce system 100. The user query can be in natural language. The user interface is a hybrid interface, which includes a first interface and a second interface.

At the block 1604, the user query is transformed into searchable keywords. The user query is transformed into the keywords that identify the user intent. The user intent is determined by the machine learning model 110. The user intent is based on user preferences like food, seating, parking, shopping etc. The user intent is based on user patterns like browsing history, purchase history, events attended, event booked, social media profiles, user's schedule, and account history. The user preferences and the user patterns are collected in real-time and dynamically updated to acquire the recent preferences and patterns. The user preferences and the user patterns are used by the machine learning algorithms of the machine learning model 110 to determine the user intent.

At the block 1606 determines a set of events based on the user intent captured in the keywords. The set of events is updated when there is a change in the user preferences and the user patterns. The set of events is displayed to the user on the second interface of the user device 106. The user provides feedback for the displayed set of events on the first interface. The set of events is indicated to the user, along with recommendations and reasons for providing the set of events to the user. The user provides the feedback either by selecting options on the hybrid interface or providing verbal or written feedback.

At the block 1608, it is determined whether the set of events meets the user preferences based on the feedback of the user. If the set of events meets the user preferences, then at block 1620, the set of events is presented to the user on the second interface. Otherwise, the user preferences are updated at the block 1610 if the user is unsatisfied with the set of results. The user may select filters and other options for the updated set of results.

The set of events is modified at the block 1612 based on user feedback and real-time updates. The modified set of events is displayed to the user on the second interface. The set of results is modified by the machine learning model 110.

At the block 1614, user feedback is received for the updated set of events. The set of events is further modified until the user is satisfied with it. If the user is satisfied, then at the block 1620, the set of events is displayed on the second interface. The chat and feedback with the user are continued on the first interface, and according to the chat and the feedback with the user, the second interface is updated with the set of events simultaneously.

At the block 1616, the set of events may be further modified based on the feedback and the real-time updates on the user preferences and user patterns. The machine learning model 110 analyses the chat and the feedback from the user and the user preferences, user patterns, and past activities to modify the set of events.

The hybrid interface is a multi-modal user interface that simultaneously displays a first interface (chat interface) and a second interface (visual interface) to the user. The first interface is used for chat-based textual interaction (question/answers/recommendations) with the user. The second interface displays the recommendations and results or events determined based on the textual interaction with the user. The hybrid interface has an AI-based engine that automatically determines the user's intentions and provides recommendations to the user rather than the user manually selecting multiple filters and struggling with the results.

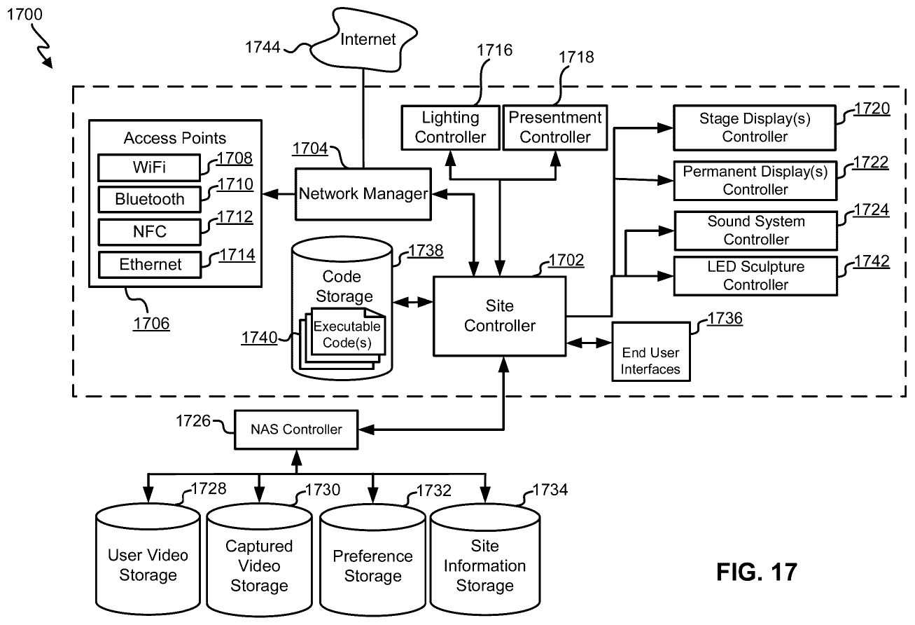

Referring to FIG. 17 illustrates a block diagram of a venue management device 1700 according to an embodiment of the present disclosure. Embodiments of a site controller 1702 use a network manager 1704 to connect via access points 1706 (using e.g., Wi-Fi 1708, Bluetooth 1710, Near Field Technology (NFC) 1712, Ethernet 1714, and/or other network connections) to other network components, such as site network and the user device(s) 104. In some embodiments, the site controller 1702 controls aspects of an event location. A broad variety of location features can be controlled by different embodiments, including permanent lights (e.g., with a lighting controller 1716), stage lights (e.g., with presentment controller 1718), stage display screens (e.g., with stage display(s) controller 1720), permanent display screens (e.g., with permanent display(s) controller 1722), the location sound system (e.g., with a sound system controller 1724), and LED sculpture controller 1742.

An NAS controller 1726 is coupled to a user video storage 1728, a captured video storage 1730, a preference storage 1732, and a site information storage 1734. The captured video storage 1730 can receive, store, and provide user videos received from end-user device(s). In some embodiments, the site controller 1702 triggers the automatic capture of images, audio, and video from the end-user device(s), such triggering being synchronized to activities in an event. Images captured by this and similar embodiments can be stored on both the capturing the end-user device(s) and the user video storage 1728. In an embodiment, the site controller 1702 can coordinate the transfer of information from the end-user device(s) to the NAS controller 1726 (e.g., captured media) with activities taking place during the event. When interacting with the end-user device(s), some embodiments of the site controller 1702 can provide end-user interfaces 1736 to enable different types of interaction. For example, as a part of engagement activities, the site controller 1702 can offer quizzes and other content to the devices. Additionally, for location determinations discussed herein, the site controller 1702 can supplement determined estimates with voluntarily provided information using the interface of an end-user interface 1736, stored in a storage that is not shown. The venue management device 1700 can be connected to the internet 1744.

In some embodiments, to guide the performance of different activities, the site controller 1702 and/or other components can use executable code tangibly stored in code storage 1738 comprising executable code 1740. In some embodiments, the site information storage 1734 can provide information regarding the site, e.g., events, resource maps, attendee information, geographic location of destinations (e.g., concessions, bathrooms, exits, etc.), and 3D models of site features and structure.

In one embodiment, every single ticket-related transaction is encrypted to save such transactions from any hacking and also use blockchain technology to make ticket sales temper proof. In other words, every single ticket-related transaction is recorded in a distributed ledger, and for every transaction, the distributed ledger gets updated with unique values.

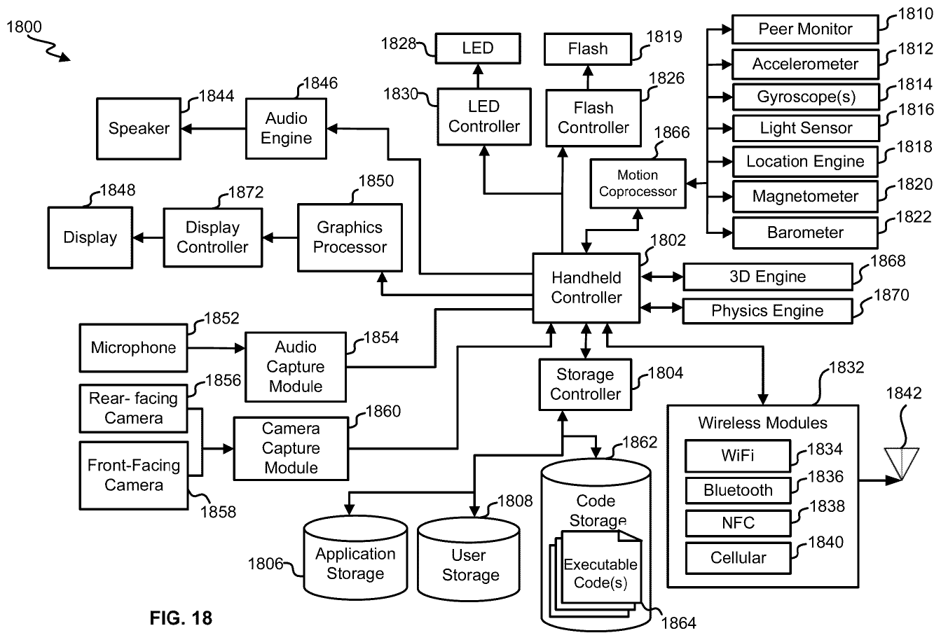

Referring to FIG. 18, illustrates a block diagram of an end-user device 1800 according to an embodiment of the present disclosure. The end-user device 1800 is the user device 104. The end-user device 1800 includes a handheld controller 1802 that can be sized and shaped to enable the handheld controller 1802 and the end-user device 1800 to be held in hand. The handheld controller 1802 can include one or more end user-device processors that can be configured to perform actions as described herein. In some instances, such actions can include retrieving and implementing a rule, retrieving an access-enabling code, generating a communication (e.g., including an access-enabling code) to be transmitted to another device (e.g., a nearby client-associated device, a remote device, a central server, a server, etc.), processing a received communication (e.g., to act in accordance with instruction in the communication, to generate a presentation based on data in the communication, or to generate a response communication that includes data requested in the received communication), and so on. In one embodiment, to guide the performance of different activities, the end-user device can use executable code tangibly stored in code storage 1862 comprising executable code 18618.

The handheld controller 1802 can communicate with a storage controller 1804 to facilitate local storage and/or retrieval of data. It will be appreciated if the handheld controller 1802 can further facilitate storage and/or retrieval of data at a remote source via generation of communications including the data (e.g., with a storage instruction) and/or requesting particular data.

The storage controller 1804 can be configured to write and/or read data from one or more data stores, such as an application storage 1806 and/or a user storage 1808. One or more data stores can include, for example, Random Access Memory (RAM), Dynamic Random Access Memory (DRAM), Read-Only Memory (ROM), flash-ROM, cache, storage chip, and/or removable memory. The application storage 1806 can include various types of application data for one or more applications loaded (e.g., downloaded, or pre-installed) onto the end-user device 1800. For example, one or more applications can include applications venue, the application running non-custodial wallets, and applications for other venue-related purchases. Further, application data can include, for example, application code, settings, profile data, databases, session data, history, cookies, and/or cache data. The user storage 1808 can include, for example, files, documents, images, videos, voice recordings, and/or audio. It would be appreciated if the end-user device 1800 can also include other types of storage and/or stored data, such as code, files, and data for an operating system configured for execution on end-user device 1800.

The handheld controller 1802 can also receive and process (e.g., in accordance with code or instructions generated in correspondence to a particular application) data from one or more sensors, and/or detection engines. One or more sensors, and/or detection engines can be configured to, for example, detect the presence, intensity, and/or the identity of (for example) another device (e.g., a nearby device or device-detectable over a particular type of networks, such as a Bluetooth, Bluetooth Low-Energy or Near-Field Communication network); an environmental, external stimulus (e.g., temperature, water, light, motion or humidity); an internal stimulus (e.g., temperature); a device performance (e.g., processor or memory usage); and/or a network connection (e.g., to indicate whether a particular type of connection is available, network strength, and/or network reliability). The sensors and detection engines include a peer monitor 1810, an accelerometer 1812, a gyroscope 1814, a light sensor 1816, a location engine 1818, a magnetometer 1820, and a barometer 1822. Singular sensor and/or detection engine can be configured to collect a measurement or decide, for example, at routine intervals or times, and/or upon receiving a corresponding request (e.g., from a processor executing an application code).

The peer monitor 1810 can monitor communications, networks, radio signals, short-range signals, etc., which can be received by a receiver of an end-user device 1800. The peer monitor 1810 can, for example, detect short-range communication from another device and/or use a network multicast or broadcast to request identification of nearby devices. Upon or while detecting another device, the peer monitor 1810 can determine an identifier, device type, associated user, network capabilities, operating system, and/or authorization associated with the device. The peer monitor 1810 can maintain and update a data structure to store a location, identifier, and/or characteristic of each of one or more nearby end-user devices 1800.

The accelerometer 1812 can be configured to detect the proper acceleration of end-user device 1800. The acceleration can include multiple components associated with various axes and/or a total acceleration. The gyroscope 1814 can be configured to detect one or more orientations (e.g., via detection of angular velocity) of end-user device 1800. The gyroscope 1814 can include, for example, one or more spinning wheels or discs, single- or multi-axis (e.g., three-axis) MEMS-based gyroscopes.

The light sensor 1816 can include, for example, a photosensor, such as a photodiode, active-pixel sensor, LED, photoresistor, or other component configured to detect a presence, intensity, and/or type of light. In some instances, one or more sensors and detection engines can include a motion detector, which can be configured to detect motion. Such motion detection can include processing data from one or more light sensors (e.g., performing a temporal and/or differential analysis).

The location engine 1818 can be configured to detect (e.g., estimate) the location of end-user device 1800. For example, the location engine 1818 can be configured to process signals (e.g., a wireless signal, GPS satellite signal, cell-tower signal, iBeacon, or base-station signal) received at one or more receivers (e.g., a wireless-signal receiver and/or GPS receiver) from a source (e.g., a GPS satellite, cellular tower or base station, or WiFi access point) at a defined or identifiable location. In some instances, the location engine 1818 can process signals from multiple sources and can estimate the location of end-user device 1800 using a triangulation technique. In some instances, the location engine 1818 can process a single signal and estimate its location as being the same as the location of the source of the signal.

The end-user device 1800 can include a flash 1819 and a flash controller 1826. The flash 1819 can include a light source, such as (for example) an LED, an electronic flash, or a high-speed flash. The flash controller 1826 can be configured to control when the flash 1819 has to emit light. In some instances, the determination includes identifying an ambient light level (e.g., via data received from the light sensor 1816) and determining that the flash 1819 is to emit light in response to a picture- or movie-initiating input when the light level is below a defined threshold (e.g. when a setting is in an auto-flash mode). In some additional or alternative instances, the determination includes determining that the flash controller 1826 is, or is not, to emit light in accordance with a flash on/offsetting. When it is determined that the flash controller 1826 is to emit light, the flash controller 1826 can be configured to control the timing of the light to coincide, for example, with a time (or right before) at which a picture or video is taken.

The end-user device 1800 can also include an LED 1828 and an LED controller 1830. The LED controller 1830 can be configured to control when the LED 1828 has to emit light. The light emission can be indicative of an event, such as whether a message has been received, a request has been processed, an initial access time has passed, etc.

The flash controller 1826 can control light emission by controlling a circuit switch to complete a circuit between a power source and the flash 1819 when the flash 1819 is to emit light. In some instances, the flash controller 1826 is wired to a shutter mechanism to synchronize the light emission and image or video data collection.

The end-user device 1800 can be configured to transmit and/or receive signals from other devices or systems (e.g., over one or more networks, such as network(s). These signals can include wireless signals, and accordingly, the end-user device 1800 can include one or more wireless modules 1832 configured to appropriately facilitate the transmission or receipt of wireless signals of a particular type. The wireless modules 1832 can include a Wi-Fi module 1834, a Bluetooth module 1836, a near-field communication (NFC) module shown as NFC 1838, and/or a cellular module 1840. Each module can, for example, generate a signal (e.g., which can include transforming a signal generated by another component of the end-user device 1800 to conform to a particular protocol and/or to process a signal (e.g., which can include transforming a signal received from another device to conform with a protocol used by another component of end-user device 1800).

The Wi-Fi module 1834 can be configured to generate and/or process radio signals with a frequency between 2.4 gigahertz and 5 gigahertz. The Wi-Fi module 1834 can include a wireless network interface card that includes circuitry to communicate using a particular standard (e.g., physical and/or link-layer standard). The Bluetooth module 1836 can be configured to generate and/or process radio signals with a frequency between 2.4 gigahertz and 2.485 gigahertz. In some instances, the Bluetooth module 1836 can be configured to generate and/or process Bluetooth low-energy (BLE or BTLE) signals with a frequency between 2.4 gigahertz and 2.485 gigahertz. The NFC 1838 can be configured to generate and/or process radio signals with a frequency of 13.56 megahertz. The NFC 1838 can include an inductor and/or can interact with one or more loop antennas. The cellular module 1840 can be configured to generate and/or process cellular signals at ultra-high frequencies (e.g., between 698 and 2690 megahertz). For example, the cellular module 1840 can be configured to generate uplink signals and/or to process received downlink signals.

The signals generated by the wireless modules 1832 can be transmitted to one or more other devices (or broadcast) by one or more antennas 1842. The signals processed by the wireless module 1832 can include those received by the one or more antennas 1842. The one or more antennas 1842 can include, for example, a monopole antenna, a helical antenna, a Planar Inverted-F Antenna (PIFA), a modified PIFA, and/or one or more loop antennas.

The end-user device 1800 can include various input and output components. An output component can be configured to present output. For example, a speaker 1844 can be configured to present an audio output by converting an electrical signal into an audio signal. An audio engine 1846 can affect particular audio characteristics, such as volume, event-to-audio-signal mapping, and/or whether an audio signal is to be avoided due to a silencing mode (e.g., a vibrate or do-not-disturb mode set at the device).

Further, a display 1848 is provided with a display controller 1872 and can be configured to present a visual output by converting an electrical signal into a light signal. The display 1848 can include multiple pixels, each of which can be individually controlled, such that the intensity and/or color of each pixel can be independently controlled. The display 1848 can include, for example, an LED- or LCD-based display.

A graphics processor 1850 can determine a mapping of electronic image data to pixel variables on a screen of the end-user device 1800. It can further adjust lighting, texture, and color characteristics in accordance with, for example, user settings.

In some instances, the display 1848 is a touchscreen display (e.g., a resistive or capacitive touchscreen) and is, thus, both an input and an output component. The graphics processor 1850 can be configured to detect whether, where and/or how (e.g., a force of) the user touched display 1848. The determination can be made based on capacitive or resistive data analysis.

An input component can be configured to receive input from a user that can be translated into data. For example, the end-user device 1800 can include a microphone 1852 that can capture sound and transform the sound into electrical signals. An audio capture module 1854 can determine, for example, when an audio signal is to be collected and/or any filter, equalization, noise gate, compression, and/or clipper to be applied to the audio signal.

The end-user device 1800 can further include a rear-facing camera 1856, and a front-facing camera 1858 every single of which can be configured to capture visual data (e.g., at a given time or across an extended period) and convert the visual data into electrical data (e.g., electronic image or video data). In some instances, the end-user device 1800 includes multiple cameras, at least two directed in different and/or substantially opposite directions. For example, the end-user device 1800 can include a rear-facing camera 1856, and a front-facing camera 1858.

A camera capture module 1860 can control, for example, when a visual stimulus is to be collected (e.g., by controlling a shutter), a duration for which a visual stimulus is to be collected (e.g., a time that a shutter is to remain open for a picture taking, which can depend on a setting or ambient light levels; and/or a time that a shutter is to remain open for a video taking, which can depend on inputs), a zoom, a focus setting, and so on. When the end-user device 1800 includes multiple cameras, the camera capture module 1860 can further determine which camera(s) is to collect image data (e.g., based on a setting). In some embodiments, components are included that assist with the processing and utilization of sensor data. Motion coprocessor 1866, 3D engine 1868, and physics engine 1870 can all process sensor data, and also perform tasks of graphics rendering related to the graphics processor 1850.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

We claim:

1. A multi-modal e-commerce system for providing artificial intelligence (AI) based ticket booking to a plurality of users, comprising:
a system application running on a user device, wherein the system application includes a hybrid interface, and the hybrid interface includes a first interface and a second interface, wherein the first interface is configured to receive a user input in a natural language via a chatbot; and
an AI-enabled engine that processes the user input to generate a searchable query, wherein the AI-enabled engine is configured to:
use the searchable query from the user input as one or more keywords to identify a plurality of results;
generate a textual output in the natural language on the first interface based on the plurality of results; and
generate a visual output on the second interface based on the plurality of results, wherein the plurality of results is based on user demographics, user preferences, and user feedback obtained from an event database.

2. The multi-modal e-commerce system of claim 1, wherein the visual output on the second interface is based on:
a text output, generated based on the user input, indicating access right information associated with an event;
a visualization of the text output;
a seat map displaying availability of access rights for the event, based on an input from a user; and
in response to one or more filters obtained from the searchable query, a user interaction element:
enabling selection of a number of access rights; and
enabling selection of a value range for the number of access rights.

3. The multi-modal e-commerce system of claim 2, wherein the access rights include one or more tickets for the event, and the plurality of results include a plurality of events.

4. The multi-modal e-commerce system of claim 1, wherein the AI-enabled engine is further configured to:
determine a user intent from the user input;
determine constraints, in response to the user intent;
query a resource data store, based on the constraints;
determine availability of access rights, based on query results;
expand the constraints if the access rights are unavailable;
retrieve access right information, based on availability of the access right information;
generate a text response, based on the access right information;
generate first interface data based on the user input and text response;
apply a first degree of visibility to the first interface data;
generate a visual response, based on the access right information;
generate second interface data, based on the visual response;
apply a second degree of visibility to the second interface data; and
present the hybrid interface on the user device, based on the first and second interface data, in response to the user input and applied filters.

5. The multi-modal e-commerce system of claim 1, wherein the textual output is a response from the searchable query including events in the natural language, and the visual output is a response from the searchable query including a visual form of the events and corresponding event information.

6. The multi-modal e-commerce system of claim 1, wherein the AI-enabled engine is further configured to acquire real-time user feedback on the plurality of results and modify the plurality of results to obtain a set of results based on the user feedback.

7. The multi-modal e-commerce system of claim 1, wherein the user demographics include user location, user data, and venue locations of events; the user preferences include user information on seat, price, artist, genres, sub-genres, social media graph of user, browsing history, web searches associated with entities of multiple resources, likes, clicks, favorites, purchase history, tickets purchased, tickets transferred, tickets sold, attendance history, friends, friends list, items displayed, venue, venue location, median price in group, and history; and the user feedback includes feedback from users for one or more events before and after attending the one or more events.

8. A method for providing artificial intelligence (AI)-based ticket booking to a plurality of users, the method comprising:
running a system application on a user device, wherein the system application includes a hybrid interface, and the hybrid interface includes a first interface and a second interface, wherein the first interface is configured to receive a user input in a natural language via a chatbot;
processing, via an AI-enabled engine, the user input to generate a searchable query;
using the searchable query from the user input as one or more keywords by the AI-enabled engine to identify a plurality of results;
generating by the AI-enabled engine a textual output in the natural language on the first interface based on the plurality of results; and
generating by the AI-enabled engine a visual output on the second interface based on the plurality of results, wherein the plurality of results is based on user demographics, user preferences, and user feedback obtained from an event database.

9. The method of claim 8, wherein the visual output on the second interface is based on:
a text response generated based on the user input indicating access right information associated with an event;
a visualization of the text response;
a seat map displaying availability of access rights for the event based on input from a user; and
in response to one or more filters obtained from the searchable query, a user interaction element enables:
selection of a number of access rights; and
selection of a value range for the number of access rights.

10. The method of claim 9, wherein the access rights include one or more tickets for the event, and the plurality of results includes a plurality of events.

11. The method of claim 8, further comprising:
determining a user intent from the user input;
determining constraints, in response to the user intent;
querying a resource data store, based on the constraints;
determining an availability of access rights, based on query results;
expanding the constraints if the access rights are unavailable;
retrieving access right information, based on availability of the access right information;
generating a text response, based on the access right information;
generating first interface data, based on the user input and the text response;
applying a first degree of visibility to the first interface data;
generating a visual response, based on the access right information;
generating second interface data, based on the visual response;
applying a second degree of visibility to the second interface data; and
presenting the hybrid interface on the user device, based on the first and second interface data, in response to the user input and applied filters.

12. The method of claim 8, wherein the textual output is a response from the searchable query including events in the natural language, and the visual output is a response from the searchable query including a visual form of the events and corresponding event information.

13. The method of claim 8, further comprises acquiring real-time user feedback on the plurality of results, and modifying the plurality of results to obtain a set of results based on the user feedback.

14. The method of claim 8, wherein the user demographics include user location, user data, and venue locations of events; the user preferences include user information on seat, price, artist, genres, sub-genres, social media graph of user, browsing history, web searches associated with entities of multiple resources, likes, clicks, favorites, purchase history, tickets purchased, tickets transferred, tickets sold, attendance history, friends, friends list, items displayed, venue, venue location, median price in group, and history; and the user feedback includes feedback from users for one or more events before and after attending the one or more events.

15. A non-transitory computer-readable medium containing instructions that, when executed by a processor, cause the processor to perform a method for providing artificial intelligence (AI) based ticket booking to a plurality of users, the method comprising:
running a system application on a user device, wherein the system application includes a hybrid interface, and the hybrid interface includes a first interface and a second interface, wherein the first interface is configured to receive user input in a natural language via a chatbot;
processing, via an AI-enabled engine, the user input to generate a searchable query;
using the searchable query from the user input as one or more keywords by the AI-enabled engine to identify a plurality of results;
generating by the AI-enabled engine a textual output in the natural language on the first interface based on the plurality of results; and
generating by the AI-enabled engine a visual output on the second interface based on the plurality of results, wherein the plurality of results is based on user demographics, user preferences, and user feedback obtained from an event database.

16. The non-transitory computer-readable medium of claim 15, wherein the visual output on the second interface is generated based on:
a text response generated based on the user input indicating access right information associated with an event;
a visualization of the text response;
a seat map displaying availability of access rights for the event, based on an input from a user; and
in response to one or more filters obtained from the searchable query, a user interaction element enables:
selection of a number of access rights; and
selection of a value range for the number of access rights.

17. The non-transitory computer-readable medium of claim 16, wherein the access rights include one or more tickets for the event, and the plurality of results includes a plurality of events.

18. The non-transitory computer-readable medium of claim 15, further comprising:
determining a user intent from the user input;
determining constraints, in response to the user intent;
querying a resource data store, based on the constraints;
determining an availability of access rights, based on query results;
expanding the constraints if the access rights are unavailable;
retrieving access right information, based on availability of the access right information;
generating a text response, based on the access right information;
generating first interface data, based on the user input and the text response;
applying a first degree of visibility to the first interface data;
generating a visual response, based on the access right information;
generating second interface data, based on the visual response;
applying a second degree of visibility to the second interface data; and
presenting the hybrid interface on the user device, based on the first and second interface data, in response to the user input and applied filters.

19. The non-transitory computer-readable medium of claim 15, wherein the textual output is a response from the searchable query including events in the natural language, and the visual output is a response from the searchable query including a visual form of the events and corresponding event information.

20. The non-transitory computer-readable medium of claim 15, wherein the method further comprises acquiring real-time user feedback on the plurality of results, and modifying the plurality of results to obtain a set of results based on the user feedback.
